(19) United States
(12) Patent Application Publication
(10) Pub. No.: US 2009/0265751 A1
(43) Pub. Date: Oct. 22, 2009

(54) Reception of ancillary 8VSB signals controlled responsive to information signaling version of broadcast standard being used

(76) Inventor: Allen LeRoy Limberg, Port Charlotte, FL (US)

Correspondence Address: ALLEN LEROY LIMBERG, ESQ., 1053 KENSINGTON STREET, PORT CHARLOTTE, FL, 33952, US

(21) Appl. No.: 12/386,738

(22) Filed: Apr. 22, 2009

Related U.S. Application Data
(60) Provisional application No. 61/125,047, filed on Apr. 22, 2008.
(60) Provisional application No. 61/131,870, filed on Jun. 14, 2008.
(60) Provisional application No. 61/132,837, filed on Jun. 23, 2008.
(60) Provisional application No. 61/135,594, filed on Jul. 22, 2008.

(51) Int. Cl. H04N 7/173; H04N 7/12

(52) U.S. Cl. 725/118; 375/240.26; 725/131; 375/E07.076

(57) ABSTRACT

Modifications to the system of broadcasting robustly coded ancillary transmissions to mobile and portable receivers of 8VSB digital television signals include version information as part of signal transmissions besides those made specifically to support an electronic service guide (ESG). This version information indicates what version of broadcast standard the signals complied with when transmitted. Such modifications allow such a receiver to determine whether it has the capability to process received ancillary transmissions usefully, without the receiver having to refer to an ESG derived from robustly coded ancillary transmissions that have been fully decoded. Such determination allows the receiver to avoid decoding of the robustly coded ancillary transmissions or to curtail such decoding after partial completion thereof, which reductions in decoding procedures reduce battery drain in battery-powered mobile and portable receivers. A receiver designed to respond to these modifications to the system of broadcasting is much less likely to malfunction owing to the ESG signal containing error when transmitted or accruing error owing to corruption during transmission.

This application claims priority from U.S. provisional patent application Ser. No. 61/125,047 filed 22 Apr. 2008, U.S. provisional patent application Ser. No. 61/131,870 filed 14 Jun. 2008, U.S. provisional patent application Ser. No. 61/132,837 filed 23 Jun. 2008, and U.S. provisional patent application Ser. No. 61/135,594 filed 22 Jul. 2008, which U.S. provisional patent applications are incorporated herein by reference.

The invention relates to digital television (DTV) signals for over-the-air broadcasting, transmitters for such broadcast DTV signals, and receivers for such broadcast DTV signals.

### BACKGROUND OF THE INVENTION

The Advanced Television Systems Committee (ATSC) published a Digital Television Standard in 1995 as Document A/53, hereinafter referred to simply as “A/53” for sake of brevity. Annex D of A/53 titled “RF/Transmission Systems Characteristics” is particularly incorporated by reference into this specification. In the beginning years of the twenty-first century efforts have been made by some in the DTV industry to provide for more robust transmission of data over broadcast DTV channels for reception by mobile and hand-held DTV receivers, collectively referred to as “M/H receivers”, without unduly disrupting the operation of so-called “legacy” DTV receivers already in the field. Robust transmission of data for reception by mobile and hand-held DTV receivers (collectively referred to as M/H receivers) was to be provided for in successive versions of an ATSC Standard for DTV Broadcasting to Mobile and Hand-held Receivers, referred to more briefly as the M/H Standard. The initial version of this standard was to be referred to as M/H 1.0; a subsequent version was to be referred to as M/H 2.0; etc. This work resulted in a Candidate Standard:ATSC-M/H Standard being published on 31 Dec. 2008, which candidate standard has been subsequently updated, one such update having been published 15 Apr. 2009. The updated candidate standard is referred to in this specification as “A/153” for short and is incorporated herein by reference.

The operation of nearly all legacy DTV receivers is disrupted if ⅔ trellis coding is not preserved throughout every transmitted data field. Also, the average modulus of the signal should be the same as for 8VSB signal as specified in the 1995 version of A/53, so as not to disrupt adaptive equalization in legacy receivers using the constant modulus algorithm (CMA). Another problem concerning “legacy” DTV receivers is that a large number of such receivers were sold that were designed not to respond to broadcast DTV signals unless de-interleaved data fields recovered by trellis decoding were preponderantly filled with (207, 187) Reed-Solomon forward-error-correction (R-S FEC) codewords of a specific type or correctable approximations to such codewords. Accordingly, in order to accommodate continuing DTV reception by such legacy receivers, robust transmissions are constrained in the following way. Before convolutional byte interleaving, data fields should be preponderantly filled with (207, 187) R-S FEC codewords of the type specified in A/53.

This constraint led to the M/H data encoded for reception by mobile and handheld DTV receivers being encapsulated within (207, 187) R-S FEC codewords of the general type specified in A/53, differing in that they are not necessarily systematic with the twenty parity bytes located at the conclusions of the codewords. The twenty parity bytes of some (207, 187) R-S FEC codewords appear earlier in the codewords to accommodate the inclusion of training signals in the fields of interleaved data. The 207-byte R-S FEC codewords invariably begin with a three-byte header similar to the second through fourth bytes of an MPEG-2 packet, with a thirteen-bit packet-identification (PID) code in the fourth through sixteenth bit positions. Except for the three-byte header and the twenty parity bytes in each (207, 187) R-S FEC codeword, the remainder of the codeword is available for “encapsulating” 184 bytes of a robust transmission.

In 2007 a standard for DTV broadcasting for robust transmission to M/H receivers was scheduled for completion by February 2009. Two of the three competing proposals for standardization employed serially concatenated convolutional coding (SCCC). The SCCC included outer convolutional coding, which was symbol-interleaved before being supplied for inner convolutional coding corresponding to the ⅔ trellis coding specified by A/53. The bytes of the symbol-interleaved outer convolutional coding were encapsulated in (207, 187) R-S FEC codewords. The standard would also provide for the transmission of data in tabular form for updating a respective electronic service guide (ESG) in each receiver. Broadcasters wanted the ESG in each receiver to be operable to supply information concerning broadcast services available to that particular receiver, but to withhold information concerning broadcast services that are unavailable to that particular receiver. There is a high likelihood that the DTV broadcasting standard will continue to be updated from time to time. Broadcasters indicated that they wished receivers to be signaled which portions of DTV broadcast signals would be successfully received only by receivers designed to receive DTV signals broadcast in accordance with such updates in the DTV broadcasting standard.

Considerable time was spent by engineers from several companies in trying to discern a system for satisfying the broadcasters' desires. Much of the thought tried to build on the already-in-place practice of signaling different types of transmission using the eight 8VSB symbols just before the final twelve 8VSB symbols of the data-field synchronization (DFS) segments. Each of these eight 8VSB symbols can be used for signaling which respective one of various versions of the DTV Broadcast Standard is used for making DTV transmissions, this arrangement having been established in an earlier DTV broadcast standard. The problem with this approach was that there was apt to be too many variations in M/H data broadcasting to be signaled by an 8-bit position code, and more efficient coding schemes presented some problem with backward compatibility of receivers already in the field. Nevertheless, this approach with its limitations was retained in A/153 for signaling a major update to the DTV broadcasting standard, and methods for more particularly specifying updates in M/H data broadcasting procedures continued to be sought.

Another approach that was considered for signaling the version of the DTV Broadcast Standard with which M/H transmissions complied was simply to signal it within electronic service guide (ESG) information sent in tabular form as part of the DTV signal. When the version information in the ESG indicated that DTV transmissions were made in compliance with a broadcasting standard that the receiver was incapable of receiving, the receiver would be partially disabled. Responsive to the version information in the ESG, control signals would be generated that would prevent the receiver from using the results of decoding the DTV transmissions in whole or in part. This approach presents problems for both the broadcaster and the user of a receiver. Avoiding error in an ESG is notoriously difficult for the broadcaster, and such error can cause receiver malfunction irritating to the user of a receiver. This approach is not well suited to a receiver avoiding decoding altogether or substantially curtailing it in procedures designed to reduce battery drain in battery-powered M/H receivers; such procedures are susceptible creating to a receiver lock-out problem. This approach not only involves a tree of connections from earlier stages of the receiver to later ones for propagating received signals. There has to be another tree of connections from the memory for the ESG back to those earlier stages of the receiver if their operation is to be controlled responsive to instructions stored in that memory.

Engineers of Coherent Logix, Inc. proposed schemes for controlling operations in the earlier stages of DTV receivers responsive to signals taken from the later stages of the receiver or responsive to signals received in parallel with M/H signals. These proposals used decision trees that branched outward as operations of successively earlier stages of a receiver were considered. This seemed to the inventor to be contrary to what would actually be required in practice. The inventor perceived that it was preferable to begin decision trees initially considering the earliest stages of reception and branching outward as operations of successively later stages of a receiver were considered. In part, this preference was based on the fact that changes in standard were more likely to impact later stages of receivers. The branching of the decision tree better mapped the possibilities of various receiver designs for different transmission modes. Growth of the number of nodes in the decision tree appeared to the inventor to be easier to control. This preferred construction of the decision tree facilitates better control of power consumption by the later stages of a receiver capable of receiving broadcasts made in accordance with later versions of the M/H standard. Later stages that were unnecessary for receiving broadcasts made in accordance with earlier versions of the M/H standard could be de-activated to save power. So could later stages that were unnecessary for receiving broadcasts made in accordance with later versions of the M/H standard. Furthermore, the practice of placing the instructions for disposition of a packet in its header simplifies insuring that the instructions are timely received, since the packet and the instructions therein are subject to similar delays in the receiver. The inventor argued in an ad hoc group of ATSC that this approach be followed instead of the one advocated by Coherent Logix, Inc. engineers.

The inventor initially focused his attention on the PIDs for the (207, 187) R-S FEC codewords used to encapsulate robust transmissions, the 207-byte MPEG-2-compatible packets in which codewords are referred to as “MHE packets” in this specification. The 204-byte payload portions of the MHE packets encapsulate the serially concatenated convolutional coding (SCCC) and associated signaling that comprise the robust transmissions. The PIDs of these MHE packets were originally proposed by LG Electronics to be the same as those designated for null MPEG-2-compatible packets. Legacy DTV receivers ignore null MPEG-2-compatible packets in the transport packet stream, but will also ignore any other MPEG-2-compatible packets that have PIDs that packet selectors in the receivers do not recognize. The inventor advocated that the 13-bit PIDs assigned by ATSC for use in the 3-byte headers of MHE packets should be different for each version of an ATSC Standard for DTV Broadcasting to Mobile and Handheld Receivers. The other eleven bits in each of these 3-byte headers could then be used by receivers for other purposes, such as to control the flow of signals to the later stages of reception. Only M/H data from those MHE packets that can be usefully received by the receiver would be passed from the earlier stages of the receiver to its later stages, this determination being made from the PIDs in the headers of the MHE packets. The inventor envisioned the tabular data for the electronic service guides (ESGs) of receivers being encapsulated within MHE packets having headers that corresponded to the types of receiver that could successfully receive the described program. The ESG of a receiver would be written only by the ESG encoded within the (207, 187) R-S FEC codewords with the header(s) for the most recent version of the M/H Standard that the receiver could usefully receive.

Null packets are used in DTV transmitters for purposes other than those associated with robust data transmission. So, experts in the DTV transmitter art agreed with the inventor that ATSC should assign a different PID or PIDs for packets that encapsulate robust transmissions and for the (207, 187) R-S FEC codewords derived from those packets. Some participants in ATSC procedures have expressed their reluctance to reserve a large number of PIDs for use in identifying MHE packets of different types, each having a respective sort of content. However, since none of the bits of each 3-byte header other than the 13-bit PID headers of the 187-byte MHE packets are used by legacy DTV receivers or by legacy M/H receivers, these other eleven bits of each 3-byte header can be used for differentiating different types of MHE packet.

The PIDs for the MHE packets in different 118-data-segment Groups of the M/H transmissions within the same M/H Frame interval can identify which of the Groups contain M/H transmissions made in compliance with an earlier version of the M/H Standard and which of the Groups contain M/H transmissions made in compliance with later versions of the M/H Standard. I.e., M/H transmissions made in compliance with different versions of the M/H Standard can be intermixed among respective Groups within the same M/H Frame interval. Receivers having different capabilities for receiving the different versions can select just the M/H Parade transmissions they are capable of receiving and ignore any other M/H Parade transmissions, such selection being made in reliance upon the PIDs of the MHE packets.

Unlike the main-service data in the 8VSB modulating signal, the M/H data stream is not convolutionally byte interleaved. The M/H data stream crosses the convolutionally byte interleaved MHE packets in the 8VSB signals transmitted through the air. This complicates control of the flow of signals to the later stages of reception using the final eleven bits in each of the 3-byte headers of the MHE packets. Accordingly, alternatively, in accordance with a further aspect of the invention, the signaling of various versions of M/H transmissions can be accomplished in whole or in part by incorporating version indications within the parallelly concatenated convolutionally coded signaling that provides operating instructions for the receiver. These operating instructions appear in respective the Transmission-Parameter-Channel and the Fast-Information-Channel portions of the M/H Groups, each of which portions are located somewhat into the M/H Group rather than at its very beginning. Furthermore, in accordance with still further aspects of the invention, the signaling of various versions of M/H transmissions can be accomplished in part by incorporating version indications into the headers of the transport stream packets in the M/H data stream. The Candidate Standard:ATSC-M/H Standard published on 31 Dec. 2008 employs internet protocol (IP) transport stream packets of variable length.

### SUMMARY OF THE INVENTION

The basic precept underlying the invention is that each new version of the ATSC DTV Broadcast Standard should be signaled within the M/H transmissions themselves, so as to permit each successive generation of receivers to receive those M/H transmissions its members are capable of receiving usefully and to ignore those M/H transmissions its members are incapable of receiving usefully. Operating instructions for the receiver include version information that indicates which generations of receivers can be operated for usefully receiving signals to be subsequently transmitted and which generations of receivers should ignore signals to be subsequently transmitted in whole or in part or even be shut down during their reception. Packets of M/H information that can be usefully received by the receiver are selectively passed along from the earlier stages of the receiver to its later stages. In accordance with an aspect of the invention, further decisions concerning which packets of M/H information are to be passed along can be made in response to version information included in headers for those packets of M/H information.

In accordance with an aspect of the invention, the tabular data for the electronic service guides (ESGs) of receivers are encapsulated within packets including M/H version information concerning which generations of receivers can successfully receive the described program. The ESG of a receiver is written only by the ESG information encoded within packets in which the included version information indicates that the receiver can usefully receive the service described in that ESG.

### BRIEF DESCRIPTION OF THE DRAWING

FIG. 1 is a schematic diagram of transmitter apparatus for broadcast digital television (DTV) signals using serially concatenated convolutional coding (SCCC) for M/H data, which transmitter apparatus in accordance with an aspect of the invention encapsulates M/H data within MHE packets included in respective (207, 187) R-S FEC codewords, the PIDs of which MHE packets indicate the version of the M/H standard that governs the transmission of the M/H data therewithin.

FIG. 2 is a table illustrating how the PIDs in the headers of (207, 187) R-S FEC codewords used to encapsulate the M/H data can signal versions of the M/H Standard in accordance with which those M/H data are transmitted.

FIG. 3 is a schematic diagram of receiver apparatus for DTV signals transmitted by transmitter apparatus of the sort shown in FIG. 1.

FIG. 4 is a more detailed schematic diagram of portions of one embodiment of the FIG. 3 receiver apparatus.

FIG. 5 is a table illustrating how the PIDs in the headers of (207, 187) R-S FEC codewords used to encapsulate the M/H data can signal more than just the versions of the M/H Standard in accordance with which those M/H data are transmitted.

FIG. 6 is a schematic diagram detailing portions of another embodiment of the FIG. 3 receiver apparatus.

FIGS. 7, 8 and 9 are schematic diagrams detailing respective portions of the FIG. 6 embodiment of the FIG. 3 receiver apparatus.

FIGS. 10 and 11 are schematic diagrams detailing variants of the FIG. 6 embodiment of the FIG. 3 receiver apparatus, which variants provide for decoding different rates of SCCC.

FIG. 12 is a detailed schematic diagram of an embodiment of the signaling encoder in FIG. 1 DTV transmitter apparatus that is modified to include version information within the TPC and FIC signaling.

FIG. 13 is a schematic diagram of modified FIG. 3 receiver apparatus that can usefully process version information within the TPC and FIC signaling.

FIG. 14 is a schematic diagram of further receiver apparatus that follows the receiver apparatus of FIG. 3, of FIGS. 3 and 4, of FIGS. 3 and 6, or of FIG. 13, as well as variants of those specific receiver apparatuses.

FIGS. 15A and 15B are beginning and concluding portions, respectively, of a flow chart illustrating the method in which packets of M/H information that can be usefully received by the receiver are selected for processing in the micro-processor included in the FIG. 14 further receiver apparatus.

### DETAILED DESCRIPTION

The M/H system provides Mobile/Handheld broadcasting services using a portion of the 19.39 Mbps ATSC 8-VSB transmission, while the remainder is still available for high-definition or multiple standard-definition television services. The M/H system is a dual-stream system: the ATSC service multiplex for existing digital television services and the M/H-service multiplex for one or more mobile, pedestrian and handheld services.

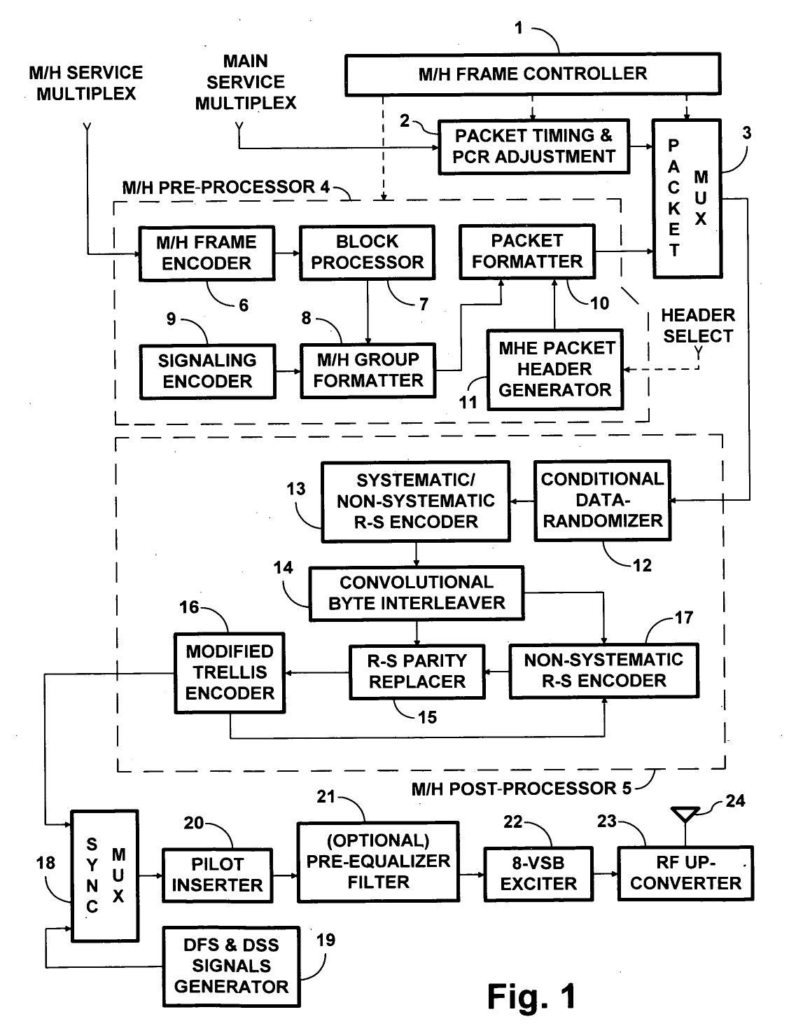

FIG. 1 shows transmitter apparatus for broadcast DTV signals using SCCC of M/H type. The transmitter apparatus receives two sets of input streams: one consists of the MPEG transport stream (TS) packets of the main-service data and the other consists of the M/H-service data. The M/H-service data are encapsulated in MPEG transport packets before emission. This avoids the reception of the main-service data by legacy 8-VSB receivers. A/153 prescribes M/H-service data being carried by internet-protocol (IP) packets. A primary function of the FIG. 1 transmitter apparatus is to combine these two types of streams into one stream of MPEG TS packets and to process the combined streams for transmission as an ATSC trellis-coded 8-VSB signal.

An M/H frame controller 1 controls these procedures. The main-service multiplex stream of data is supplied to a packet timing and PCR adjustment unit 2 before the packets of that stream are routed to a packet multiplexer 3 to be time-division multiplexed with MHE packets encapsulating M/H-service data. (PCR is the acronym for “Program Clock Reference”.) Because of their time-division multiplexing with the MHE packets, changes have to be made to the time of emission of the main-service stream packets compared to the timing that would occur with no M/H stream present. The packet timing and PCR adjustment unit 2 makes these timing changes responsive to control signals supplied thereto from the M/H frame controller 1. The packet multiplexer 3 time-division multiplexes the main-service stream packets with MHE packets encapsulating M/H-service data, as directed by control signals from the M/H frame controller 1. The operations of the M/H transmission system in regard to the M/H data are apportioned between two stages: an M/H pre-processor 4 and an M/H post-processor 5.

The function of the pre-processor 4 is to rearrange the M/H-service data into an M/H data structure, to enhance the robustness of the M/H-service data by additional FEC processes, to insert training sequences, and subsequently to encapsulate the processed enhanced data into MHE packets within the ancillary transport stream (TS). The operations performed by the pre-processor 4 include M/H frame encoding, block processing, M/H Group formatting, packet formatting and M/H signaling encoding. The M/H frame controller 1 provides the necessary transmission parameters to the pre-processor 4 and controls the multiplexing of the main-service data packets and the M/H-service data packets by the packet multiplexer 3 to assemble each M/H frame.

The function of the post-processor 5 is to process the main-service data by normal 8-VSB encoding and to re-arrange the pre-processed M/H-service data in the combined stream to ensure backward compatibility with ATSC 8-VSB. Main-service data in the combined stream are processed exactly the same way as for normal 8-VSB transmission: randomizing, RS encoding, convolutional byte interleaving and trellis encoding. The M/H-service data in the combined stream are processed differently from the main-service data, with the pre-processed M/H-service data bypassing data randomization. The pre-processed M/H-service data is subjected to non-systematic RS encoding which re-arranges their bytes. The non-systematic RS encoding allows the insertion of periodically spaced long training sequences without disturbing legacy receivers. Additional operations are done on the pre-processed M/H-service data to initialize the trellis encoder memories at the beginning of each training sequence included in the pre-processed M/H-service data.

More specifically, the M/H-service multiplex stream of data is supplied to the M/H pre-processor 4 for processing and subsequent encapsulation in the payload fields of MPEG null transport packets. The MHE transport packets are supplied to the packet multiplexer 3 after data encapsulation within their payload fields is completed.

Still more specifically, the M/H-service multiplex stream of data is supplied to an M/H frame encoder 6 which provides transverse Reed-Solomon (TRS) coding of data packets. The data packets are also subjected to periodic cyclic redundancy check (CRC) coding to locate byte errors for the TRS coding. Each M/H frame is composed of one or two frames of the TRS coding, and the data in each frame of the TRS-CRC coding are randomized independently from one other and from the data of the main-service multiplex. The M/H frame encoder 6 is connected for supplying packets of M/H-service data and packets of TRS parity bytes within consecutive blocks of the TRS-CRC two-dimensional coding to a block processor 7, as input signal thereto. The block processor 7 includes encoders for each type of single-phase outer convolutional coding used in the SCCC and respective subsequent interleavers for successive 2-bit symbols of each type of single-phase outer convolutional coding.

AN M/H Group formatter 8 is connected for receiving the interleaved outer convolutional coding from the block processor 7 as input addressing signal. The M/H Group formatter 8 includes an interleaved M/H Group format organizer that operates on the M/H Group format as it will appear after the ATSC data interleaver. The interleaved M/H Group format organizer maps the FEC coded M/H-service data from the block processor into the corresponding M/H blocks of a group, adding pre-determined training data bytes and data bytes to be used for initializing the trellis encoder memories. The interleaved M/H Group format organizer inserts place-holder bytes for main-service data and for non-systematic RS parity. Also, place-holder bytes for the 3-byte headers of MHE packets are inserted in accordance with an aspect of the invention disclosed herein. The interleaved M/H Group format organizer adds some dummy bytes to complete construction of the intended M/H Group format. The interleaved M/H Group format organizer assembles a group of 118 consecutive TS packets. Some of these TS packets are composed of the interleaved outer convolutional coding supplied by the block processor 7. Others of these TS packets are prescribed training signals stored in read-only memory within the M/H Group formatter 8 and inserted at prescribed intervals within the group. Still others of these TS packets are generated by a signaling encoder 9.

The M/H transmission system has two kinds of signaling channels generated by the signaling encoder 9. One is the Transmission Parameter Channel (TPC), and the other is the Fast Information Channel (FIC). The TPC is for signaling the M/H transmission parameters such as various FEC modes and M/H frame information. The FIC facilitates the selection of M/H data concerning specific services from greater amounts of M/H data that can be recovered by the earlier stages of an M/H receiver. This selected M/H data concerning specific services is subsequently processed by the later stages of the M/H receiver. The earlier stages of the receiver are apt to be “hardware” within special-purpose integrated circuitry dedicated to the task of recovering M/H data. Many of the later stages of the M/H receiver are apt to be realized within a general-purpose micro-processor programmed by appropriate software.

The interleaved M/H Group format organizer is followed in cascade connection by a byte de-interleaver within the M/H Group formatter 8. This byte de-interleaver complements the ATSC convolutional byte interleaver. The M/H Group formatter 8 is connected for supplying the response of this de-interleaver as its output signal, which is applied as input signal to a packet formatter 10. Initially, the packet formatter 10 expunges the main-service data place-holders and the RS parity place-holders that were inserted by the interleaved Group format organizer for proper operation of the byte de-interleaver in the M/H Group formatter 8. In accordance with an aspect of the invention, the packet formatter 10 subsequently replaces the 3-byte place holders for MHE packet headers with an MHE packet header supplied from an MHE packet header generator 11 and inserts an MPEG TS sync byte before each 187-byte data packet as a prefix thereof. The packet formatter 10 supplies 118 M/H-data-encapsulating TS packets per group to the packet multiplexer 3, which time-division multiplexes the M/H-service TS packets and the main-service TS packets to construct M/H frames.

In some cases the MHE packet header generator 11 is a read-only memory storing a variety of possible MHE packet headers, the appropriate one of which is selected by a HEADER SELECT signal supplied to the ROM as read address. In other cases the MHE packet header can be hard-wired into the DTV transmitter apparatus. In still other cases the MHE packet header may be assembled from bits supplied from more than one source of control signal.

The M/H frame controller 1 controls the packet multiplexer 3 in the following way when the packet multiplexer schedules the 118 TS packets from the packet formatter 11. Thirty-seven packets immediately precede a DFS segment in a 313-segment VSB field of data, and another eighty-one packets immediately succeed that DFS segment. The packet multiplexer 3 reproduces next-in-line main-service TS packets in place of MPEG null packets that contain place-holder bytes for main-service data in their payload fields. The packet multiplexer 3 is connected to supply the TS packets it reproduces to the post-processor 5 as input signal thereto.

More specifically, the packet multiplexer 3 is connected to apply the TS packets it reproduces to a conditional data randomizer 12 as the input signal thereto. The conditional data randomizer 12 suppresses the sync bytes of the 188-byte TS packets and randomizes the remaining data in accordance with conventional 8VSB practice, but only on condition that it is not encapsulated M/H-service data. The encapsulated M/H-service data bypass data randomization. The other remaining data are randomized per A/53, Annex D, § 4.2.2.

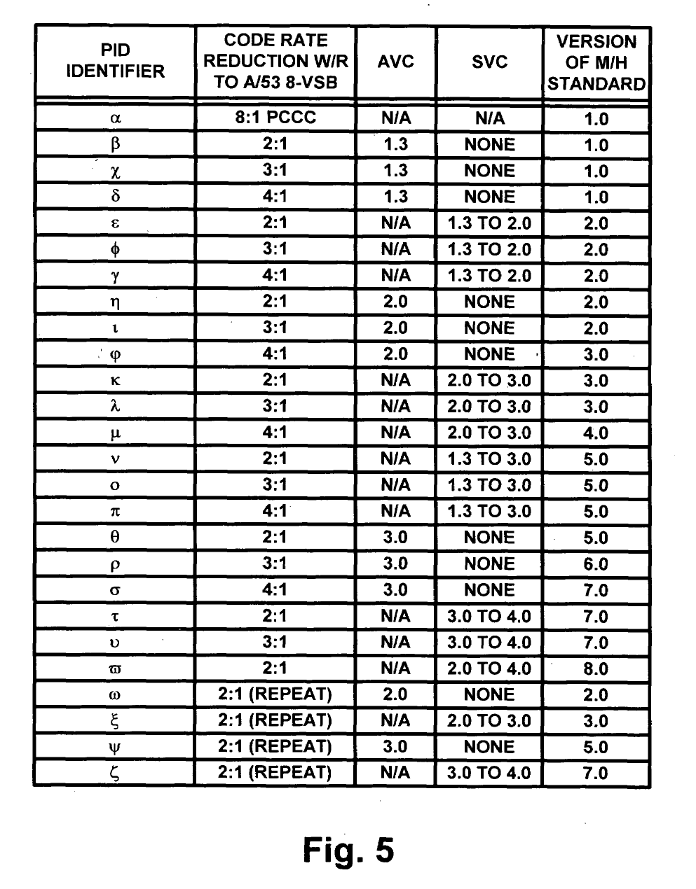

An encoder 13 for systematic and non-systematic (207, 187) Reed-Solomon codes is connected to receive, as its input signal, the 187-byte packets that the conditional data randomizer 12 reproduces with conditional data randomization. The R-S parity generator polynomial and the primitive field generator for the Reed-Solomon encoder 13 are the same as those A/53, Annex D, FIG. 5 prescribes for (207, 187) Reed-Solomon coding. When the R-S encoder 13 receives a main-service data packet, the R-S encoder 13 performs the systematic R-S coding process prescribed in A/53, Annex D, § 4.2.3, appending the twenty bytes of R-S parity data to the conclusion of the 187-byte packet. When the R-S encoder 13 receives an M/H-service data packet, the RS encoder 13 performs a non-systematic RS encoding process. The twenty bytes of R-S parity data obtained from the non-systematic RS encoding process are inserted in a prescribed parity byte location within the M/H data packet.

A convolutional byte interleaver 14 is connected for receiving as its input signal the 207-byte R-S codewords that the R-S encoder 13 generates. The byte interleaver 14 is generally of the type specified in A/53, Annex D, § 4.2.4. The byte interleaver 14 is connected for supplying byte-interleaved 207-byte R-S codewords via a Reed-Solomon parity replacer 15 to a modified trellis encoder 16. The basic trellis encoding operation of the modified trellis encoder 16 is similar to that specified in A/53, Annex D, § 4.2.4. The trellis encoder 16 converts the byte-unit data from the byte interleaver 14 to symbol units and performs a 12-phase trellis coding process per Section 6.4.1.4 Main Service Trellis Coding of A53-Part-2-2007. In order for the output data of the trellis encoder 16 to include pre-defined known training data, initialization of the memories in the trellis encoder 16 is required. This initialization is very likely to cause the R-S parity data calculated by the R-S encoder 13 prior to the trellis initialization to be erroneous. The R-S parity data must be replaced to ensure backward compatibility with legacy DTV receivers. Accordingly, the trellis encoder is connected for supplying the changed initialization byte to an encoder 17 for non-systematic (207, 187) Reed-Solomon codes, which encoder 17 re-calculates the RS parity of the affected M/H packets. The encoder 17 is connected for supplying the re-calculated R-S parity bytes to the R-S parity replacer 15, which substitutes the re-calculated R-S parity bytes for the original R-S parity bytes before they can be supplied to the modified trellis encoder 16. That is, the R-S parity replacer 15 reproduces the output of the byte interleaver 14 as the data bytes for each packet in its output signal, but reproduces the output of the non-systematic R-S encoder 17 as the R-S parity for each packet in its output signal. The R-S parity replacer 15 is connected to supply the resulting packets in its output signal to the modified trellis encoder 16 as the input signal thereto.

A synchronization multiplexer 18 is connected for receiving as the first of its two input signals the ⅔ trellis-coded data generated by the modified trellis encoder 16. The sync multiplexer 18 is connected for receiving its second input signal from a generator 19 of synchronization signals comprising the data segment sync (DSS) and the data field sync (DFS) signals. The DSS and DFS are time-division multiplexed with the ⅔ trellis-coded data per custom in the output signal from the sync multiplexer 18, which is supplied to a pilot inserter 20 as input signal thereto. The pilot inserter 20 introduces a direct component offset into the signal for the purpose of generating a pilot carrier wave during subsequent balanced modulation of a suppressed intermediate-frequency (IF) carrier wave. The output signal from the pilot inserter 20 is a modulating signal, which may be passed through a pre-equalizer filter 21 before being supplied as input signal to an 8-VSB exciter 22 to modulate the suppressed IF carrier wave. The 8-VSB exciter 22 is connected for supplying the suppressed IF carrier wave to a radio-frequency up-converter 23 to be converted upward in frequency to repose within the broadcast channel. The upconverter 23 also amplifies the power of the radio-frequency (RF) signal that it applies to the broadcast antenna 24.

The nature of the PID that the MHE packet header generator 11 supplies to the packet formatter 10 is what is of particular concern with regard to certain aspects of the invention. The PID is chosen for signaling the version of the M/H standard in accordance with which the M/H data are transmitted, but only if the data will be usefully received only by receivers designed for receiving signals transmitted in accordance with that particular version of the M/H standard. Otherwise, if M/H data are transmitted in accordance with more than one version of the M/H standard, the portions of the M/H data common to both standards are transmitted in MHE packets having PIDs identifying the earliest version of the M/H standard that can usefully receive the data.

The potential problem with this arrangement is that a receiver designed for a later version of the M/H standard may usefully receive only some portions of the robust data transmitted in accordance with an earlier version of the M/H standard. This problem can be sidestepped by providing a plurality of special PIDs for MHE packets in each version of the M/H standard. One special PID signals MHE packets that are useful only to transmissions in accordance with that particular version of the standard. This enables a receiver not to reproduce the contents of those MHE packets for application to later stages of the receiver. Another special PID signals MHE packets that are useful only to transmissions in accordance with that particular version of the standard and its immediate successor. The PID of the MHE packet can be thought of as an extension of the PIDs of the packets encapsulated therein.

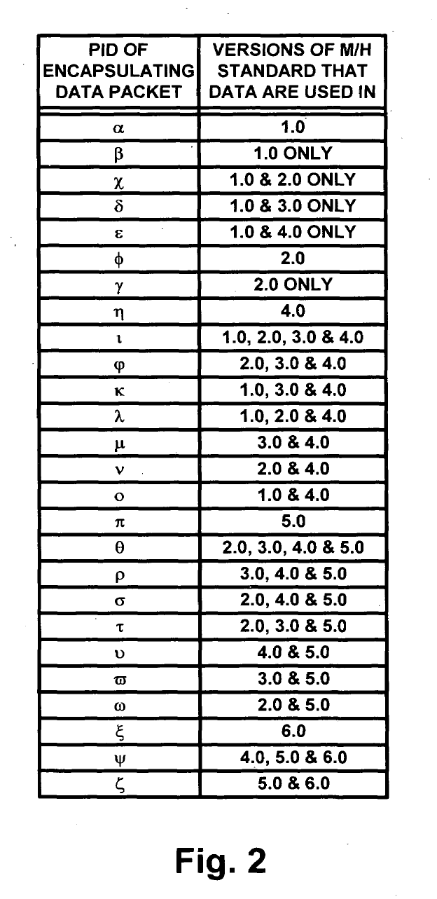

The table shown in FIG. 2 illustrates how the PIDs in the headers of (207, 187) R-S FEC codewords used to encapsulate the M/H data can signal versions of the M/H Standard in accordance with which those M/H data are transmitted. The Greek letters in the left column of the table represent different 13-bit PIDs. A DTV receiver is expected to know the versions of the M/H Standard used for transmitting DTV signals that the receiver can usefully receive.

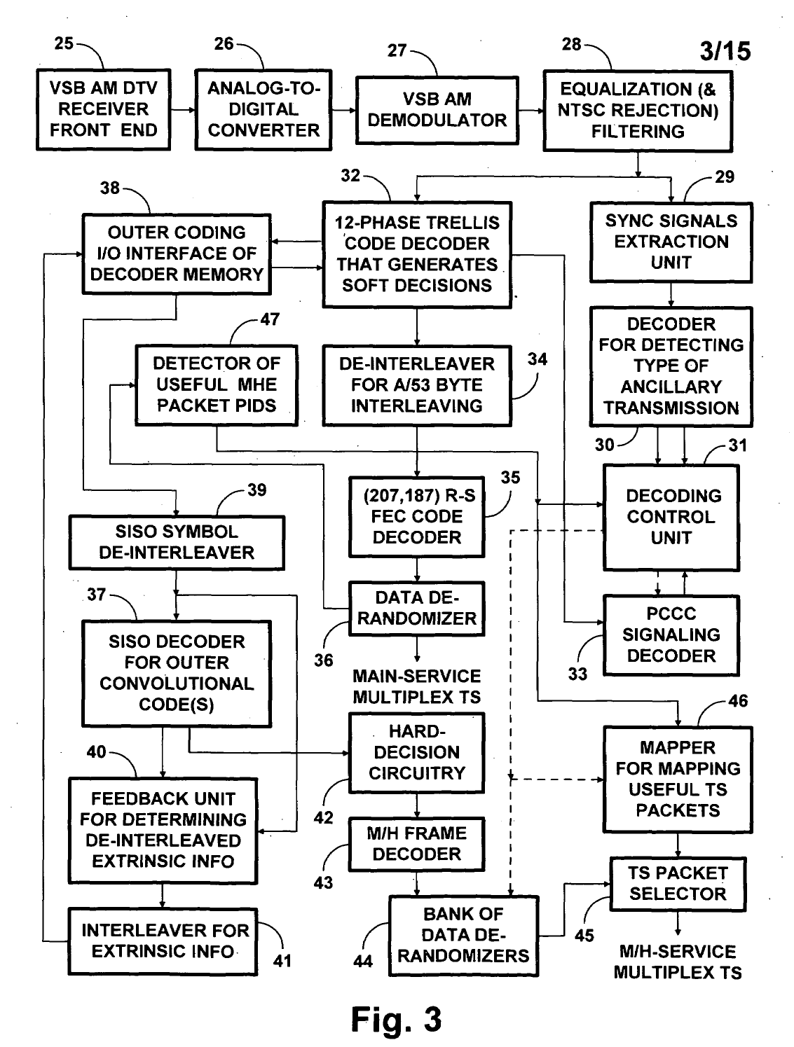

FIG. 3 shows receiver apparatus for DTV signals transmitted by M/H transmitter apparatus of the sort shown in FIG. 1. The FIG. 3 DTV receiver apparatus includes a vestigial-sideband amplitude-modulation (VSB AM) DTV receiver front-end 25 for selecting a radio-frequency DTV signal for reception, converting the selected RF DTV signal to an intermediate-frequency DTV signal, and for amplifying the IF DTV signal. An analog-to-digital converter 26 is connected for digitizing the amplified IF DTV signal supplied from the DTV receiver front-end 25. A demodulator 27 is connected for demodulating the digitized VSB AM IF DTV signal to generate a digitized baseband DTV signal, which is supplied to digital filtering 28 for equalization of channel response and for rejection of co-channel interfering NTSC signal. Synchronization signals extraction circuitry 29 is connected for receiving the digital filtering 28 response. Responsive to data-field-synchronization (DFS) signals, the sync extraction circuitry 29 detects the beginnings of data frames and fields. Responsive to data-segment-synchronization (DSS) signals, the sync extraction circuitry 29 detects the beginnings of data segments. The FIG. 3 DTV receiver apparatus uses the DSS and DFS signals for controlling its operations similarly to the way this is conventionally done in DTV receivers. FIG. 3 does not explicitly show the circuitry for effecting these operations.

A decoder 30 for detecting the type of ancillary transmission responds to 8-bit sequences contained in final portions of the reserved portions of DFS signals separated by the sync extraction circuitry 29. The decoder 30 is connected for indicating the type of ancillary transmission to decoding control unit 31 that controls turbo decoding in the FIG. 3 DTV receiver apparatus. The type of ancillary transmission that the decoder 30 detects may be one that conditions the decoder 30 to extract further information concerning the ancillary transmission from the initial portions of the reserved portions of DFS signals separated by the sync extraction circuitry 29. The decoder 30 is connected for supplying such further information to the decoding control unit 31. This further information is apt to include pointers to portions of the data field that contain signaling information describing ancillary transmission in greater detail.

FIG. 3 shows a 12-phase trellis decoder 32 connected for receiving the digital filtering 28 response. In actual practice the 12-phase trellis decoder 32 shown in FIG. 3 is apt to be a plurality of component 12-phase trellis decoders, each component 12-phase trellis decoder capable of decoding the digital filtering 28 response. Such construction of the trellis decoder 32 facilitates turbo decoding of various types of SCCC being carried on independently of each other, each using separate temporary storage of data.

FIG. 3 further shows the 12-phase trellis decoder 32 connected for supplying trellis-decoding results to a signaling decoder 33. In actual practice, these trellis-decoding results may be supplied by one of a plurality of component 12-phase trellis decoders in the trellis decoder 32, and the signaling decoder 33 may be connected to feed back extrinsic information to that component trellis decoder to implement turbo decoding. The component 12-phase trellis decoder will include memory for storing the digital filtering 28 response for updating by the extrinsic information. The decoding control unit 31 enables operation of the signaling decoder 33 during those portions of the data field that contain signaling information describing how the decoding of ancillary transmissions should proceed. To keep FIG. 3 from being too cluttered to be understood readily, FIG. 3 does not explicitly show most of the connections of the decoding control unit 31 to the elements involved in decoding the SCCC. The decoding control unit 31 not only controls turbo decoding procedures; it also controls the procedures for performing two-dimensional decoding of the RS Frames recovered by those turbo decoding procedures, exercising that control over the M/H Frame decoder which performs that two-dimensional decoding.

FIG. 3 shows the 12-phase trellis decoder 32 further connected for supplying trellis-decoding results to a byte de-interleaver 34. The byte de-interleaver 34 provides byte-by-byte de-interleaving of these results to generate input signal for a Reed-Solomon decoder 35 of the de-interleaved (207, 187) R-S FEC codewords supplied from the byte de-interleaver 34. The de-interleaving of the byte de-interleaver 34 complements the convolutional byte interleaving prescribed by A/53, Annex D, §4.2.4. In actual practice, the trellis-decoding results may be supplied to the byte de-interleaver 34 by one of a plurality of component 12-phase trellis decoders in the trellis decoder 32. Preferably, the de-interleaved (207, 187) R-S FEC codewords are accompanied by soft-decision information, and the R-S decoder 35 is of a sort that can use the soft-decision information to improve overall performance of the decoders 32 and 35. The R-S decoder 35 is connected for supplying packets of randomized hard-decision data to a data de-randomizer 36, which exclusive-ORs the bits of the randomized hard-decision data with appropriate portions of the PRBS prescribed in A/53, Annex D, §4.2.2 to generate a first transport stream. This first transport stream is constituted in part of MPEG-2-compatible packets of de-randomized principal data. Insofar as the R-S decoder 35 is capable, it corrects the hard-decision 187-byte randomized data packets that it supplies to the data de-randomizer 36. The output signal from the data de-randomizer 36 reproduces the main-service multiplex transport stream.

FIG. 3 shows the 12-phase trellis decoder 32 further connected as a soft-input, soft-output (SISO) inner decoder in a turbo decoding loop that also includes a soft-input, soft-output (SISO) outer decoder 37. In actual practice, another of a plurality of component 12-phase trellis decoders in the trellis decoder 32 is connected to function as the SISO inner decoder in this turbo decoding loop, and the SISO outer decoder 37 is connected to feed back extrinsic information to that component trellis decoder to implement turbo decoding. The turbo decoding procedures often involve iterations of both decoding of the inner convolutional code of the SCCC by the SISO trellis decoder 32 and decoding of the outer convolutional code of the SCCC by the SISO outer decoder 37. The component 12-phase trellis decoder will include memory for storing the digital filtering 28 response for updating by the extrinsic information. The decoding operations of the decoders 32 and 37 are staggered in time. The decoders 32 and 37 may be of types that use the soft-output Viterbi algorithm (SOVA) for evaluating code trellises, but preferably are of types that use the logarithmic maximum a posteriori algorithm (log-MAP) for such evaluations. In any case, both of the decoders 32 and 37 comprise memory for temporary storage of the soft-decisions that they respectively generate.

An input/output interface 38 is used for accessing selected portions of the memory for temporary storage of soft-decisions in the trellis decoder 32 that contain soft-decisions related to the interleaved outer convolutional coding of the SCCC. This I/O interface 38 includes a memory address generator, the operation of which is controlled by the decoding control unit 31. Responsive to control by the decoding control unit 31, the I/O interface 38 reads soft-decisions related to the reproduced interleaved outer convolutional coding of the SCCC to the input port of a symbol de-interleaver 39.

The symbol de-interleaver 39 is connected for de-interleaving the interleaved outer convolutional coding of the SCCC and supplying soft-decisions related to the de-interleaved outer convolutional coding to the SISO outer decoder 37 and to a feedback unit 40 for determining de-interleaved extrinsic information to be fed back for turbo decoding procedures. The symbol de-interleaver 39 is customarily constructed from random-access memory (RAM) written with write addressing different from its read addressing when subsequently read. The SISO outer decoder 37 is connected for supplying soft decisions concerning its decoding results to the feedback unit 40 for determining de-interleaved extrinsic information feedback. The RAM in the symbol de-interleaver 39 can be re-read to supply the feedback unit 40 with soft decisions concerning the input signal of the SISO outer decoder 37 contemporaneously with soft decisions concerning the output signal of the SISO outer decoder 37. This eliminates the need for additional temporary memory within the feedback unit 40 for temporally aligning the input and output signals of the SISO outer decoder 37.

The feedback unit 40 for determining de-interleaved extrinsic information to be fed back for turbo decoding procedures supplies that information to an interleaver 41 that interleaves the soft decisions with regard to two-bit symbols of that information to generate extrinsic information. The extrinsic information is fed back through the I/O interface 38 to update the trellis-coded digital filtering 28 response that is temporarily stored in selected portions of the memory in the trellis decoder 32 that hold the time-slice that is being turbo decoded.

FIG. 3 shows the symbol de-interleaver 39 further connected for supplying de-interleaved soft decisions from the trellis decoder 32 to hard-decision circuitry 42. FIG. 3 also shows the SISO decoder 37 connected for subsequently supplying its soft decisions to the hard-decision circuitry 42. The hard-decision circuitry 42 generates a set of hard decisions in response to each set of soft decisions supplied thereto. The hard-decision circuitry 42 is connected to supply the resulting hard decisions as to the randomized data to an M/H frame decoder 43 as input signal thereto. The M/H frame decoder 43 is connected for supplying its output signal to a bank 44 of data de-randomizers as their input signals. The decoding control unit 31 is connected for supplying a control signal that selects the response of one of the bank 44 of data de-randomizers that is suitable for reproducing the M/H-service multiplex transport stream.

The FIG. 3 receiver apparatus differs from previous receiver apparatus in the following respects. A transport stream packet selector 45 is connected for receiving, as a TS input signal thereof, the selected response of the bank 44 of data de-randomizers. A mapper 46 for mapping useful TS packets is connected for supplying a control signal to the transport stream packet selector 45 that conditions it to reproduce only those TS packets of the M/H-service multiplex that can be utilized by the subsequent stages of the receiver. The mapper 46 for mapping useful TS packets contains memory for temporary storage of maps corresponding to the RS Frames in temporary storage in memory within the M/H frame decoder 43. A detector 47 of useful MHE packet PIDs is connected for receiving header information concerning de-randomized 8-VSB packets from the data de-randomizer 36. The MHE packet PIDs used in versions of the M/H standard that the FIG. 3 receiver apparatus is not designed to receive are considered by the detector 47 not to be useful. The detector 47 is connected to supply indications that it has detected MHE packet PIDs that it considers to be useful, which indications are applied as input signal to the mapper 46 for mapping useful TS packets. Those portions of the TS packet map that would be filled with data useful to the FIG. 3 receiver are conditioned for supplying the TS packet selector 45 with control signal that conditions the selector 45 to reproduce the TS packets from the bank 44 of data de-randomizers. Those portions of the TS packet map that would be filled with data not useful to the FIG. 3 receiver are conditioned for supplying the TS packet selector 45 with control signal that conditions the selector 45 not to reproduce the TS packets from the bank 44 of data de-randomizers. Note that the conditioning of the selector 45 either to reproduce or not to reproduce the TS packets from the bank 44 of data de-randomizers is done on an individual M/H Group by individual M/H Group basis. This accommodates some M/H Parades being transmitted in accordance with a version of the M/H Standard that the M/H receiver is equipped to receive successfully, along with other M/H Parades being transmitted in accordance with a version of the M/H Standard that the M/H receiver is not equipped to receive successfully. These two sets of M/H Parades can both be transmitted within the same M/H Frames.

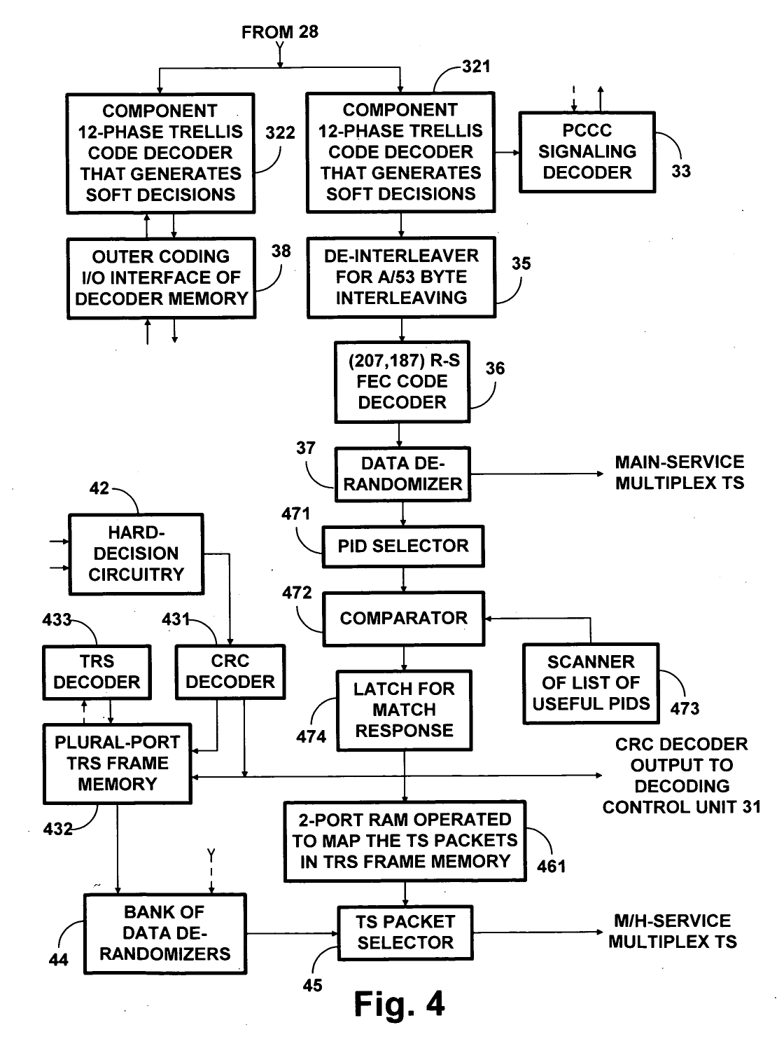

FIG. 4 shows details of portions of one embodiment of the FIG. 3 receiver apparatus. FIG. 4 shows the 12-phase trellis decoder 32 more specifically as comprising component 12-phase trellis decoders 321 and 322 together with a random-access memory 323 operated to delay the response of the digital filtering 28 applied as input signal to the trellis decoder 322. This delay is long enough to compensate for the latent delay of the byte de-interleaver 35 and the R-S decoder 36 connected in cascade after the component trellis decoder 321, which is connected to receive the digital filtering 28 response without delay as input signal thereto. (In actual practice there will be considerable delay associated with turbo decoding and M/H Frame decoding procedures, and shim delay may be required in the control signals applied to the TS packet selector 45.) The component trellis decoder 321 is connected for supplying soft decisions to the PCCC decoder 33 as input signal thereto. The I/O interface 38 connects with the component trellis decoder 321.

FIG. 4 shows the M/H frame decoder 43 more specifically as comprising a decoder 431 for 2-byte cyclic redundancy check (CRC) codes, a plural-port TRS frame memory 432, and a decoder 432 for a selected one of the possible transverse Reed-Solomon (TRS) codes. The hard-decision circuitry 42 is connected for supplying hard decisions to the decoder 431 for CRC code. The decoder 431 reproduces the hard decisions that the decoder 431 determines to be the initial portions of valid CRC codewords. The decoder 431 also generates an indication concerning the probable validity of each CRC codeword, which indication is forwarded to the decoding control unit 31. In some designs the decoding control unit 31 may discontinue iterations of the turbo decoding procedures responsive to indication that a CRC codeword is probably valid. The decoder 431 is connected for writing the initial portions of CRC codewords into TRS frame memory 432 together with the indications of the probable validity of each of those codewords. The indications of the probable validity of each of those codewords can be used for locating byte errors during TRS decoding procedures. When the TRS frame memory 432 has been loaded with a TRS frame and the error-location information, its contents are supplied column of bytes by column of bytes to the decoder 432 for a selected one of the possible TRS codes. After correcting as many byte errors as possible in each column of bytes, the decoder 432 returns the column of bytes to its original location within the TRS frame memory 432. After all the columns of bytes have been corrected insofar as possible and returned to their original locations within the TRS frame memory 432, the contents of selected slots in the TRS frame memory are read row of bytes after row of bytes. This supplies input signals to one or more data de-randomizers in the bank 44 of data de-randomizers.

FIG. 4 shows a detector of useful MHE packet PIDs that comprises a PID selector 471, a comparator 472, a scanner 473 for scanning a list of PIDs that the receiver will be capable of usefully receiving, and a latch 474 for any match output signal from the comparator 472. More specifically, the PID selector 471 is connected for selecting to a first input port of the comparator 472 a respective 13-bit PID from each data packet of the main-service multiplex TS supplied as response from the data de-randomizer 36. The scanner 473 is connected for scanning a list of PIDs that the receiver will be capable of usefully receiving to a second input port of the comparator 472. The comparator 472 compares those PIDs with the PID selected to its first input port well before the PID selector 471 selects the next PID. The comparator 472 supplies a ONE response when and only when one of the PIDs scanned to its second input port matches the PID selected to its first input port. Otherwise, the comparator 472 supplies a ZERO response. The comparator 472 is connected for supplying its response to a latch 474 for any match output signal from the comparator 472. More particularly, the latch 474 can be a set-reset flip-flop, set by ONE response from the comparator 472 and reset by a ONE generated during the DSS interval. The true output of the set-reset flip-flop latches any indication that the PID selected by the PID selector 471 is a useful one.

FIG. 4 shows a dual-port random-access memory 461 that is a principal component of the mapper 46 for mapping useful TS packets. FIG. 4 shows the RAM 461 connected for having the latch 474 response for each PID selected by the PID selector 471 written to a suitable map location. FIG. 4 does not explicitly show the write address generator for supplying write addresses to the RAM 461 nor the read address generator for supplying read addresses to the RAM 461. The read addresses skip certain locations in the RAM 461 to take into account (a) that the code rate for ancillary data is an aliquot fraction of 8VSB code rate and (b) that the ancillary data does not pack into an integral number of MHE packets. The read address generator is connected for supplying the TS packet selector 45 indications of whether each TS packet supplied to it is useful to the receiver. The read address generator supplies these indicates at a rate that takes into account the variable processing times associated with successful turbo decoding procedures. Responsive to such indications, the TS packet selector 45 marks each of the TS packets it reproduces as being either useful or non-useful to the receiver.

The configuration shown in FIG. 4 is built on the assumption that the variable processing times associated with successful turbo decoding procedures is always longer than the latent delay through the byte de-interleaver 34, the R-S decoder 35, the data de-randomizer 36, and the succeeding elements used in writing a packet map into the RAM 461. This may not always be the case if the latent delay of the symbol de-interleaver used in turbo coding is short. In such case the response of the digital filtering 28 can be delayed by digital delay line before application to the component 12-phase trellis decoder 321. An alternative strategy is to extract the randomized PIDs from the memory in the byte de-interleaver 34 and de-randomizing them without waiting for R-S decoding and data de-randomization procedures being performed by the R-S decoder 35 and the data de-randomizer 36. The drawback of this alternative strategy is that there is no chance of byte error in a PID being corrected by R-S decoding.

The FIG. 5 table illustrates how the PIDs in the headers of (207, 187) R-S FEC codewords used to encapsulate the M/H data can signal more than just the versions of the M/H Standard in accordance with which those M/H data are transmitted. The conjecture implicit in the table is that eventually there will have been eight successive versions 1.0, 2.0, 3.0, 4.0, 5.0, 6.0, 7.0 and 8.0 of the ATSC Digital Broadcast Standard for Mobile and Handheld Receivers. These eight successive versions are presumed to offer, at least for a time, backward compatibility for receivers designed for earlier versions of the standard. The FIG. 5 table illustrates that the PIDs in the headers of (207, 187) R-S FEC codewords used to encapsulate the M/H data can signal both the code rate of the ancillary transmissions and the specific use for the ancillary transmissions. A DTV receiver of M/H signals can use the code rate information to help in the control of turbo decoding procedures. The information concerning the ancillary transmissions including PCCC signaling information can be used for directing the PCCC signaling information to a decoder therefor. Some of the information concerning the specific use for the ancillary transmissions can be used to help control of procedures to combine AVC and SVC data. Other of the information concerning the specific use for the ancillary transmissions can be used to help control of procedures for receiving staggercast data.

Audio data are presumed to be encapsulated in the same MHE packets as AVC video data of similar code rate. AVC and SVC video date transmitted with 2:1 reduction in code rate and parenthetically indicated to be repeat data are the re-transmitted data used for staggercasting that combines earlier and later transmissions of the same M/H data in the physical layer. The repeat transmissions preferably use symbol interleaving of the outer convolutional coding that is different from that used in the original transmissions.

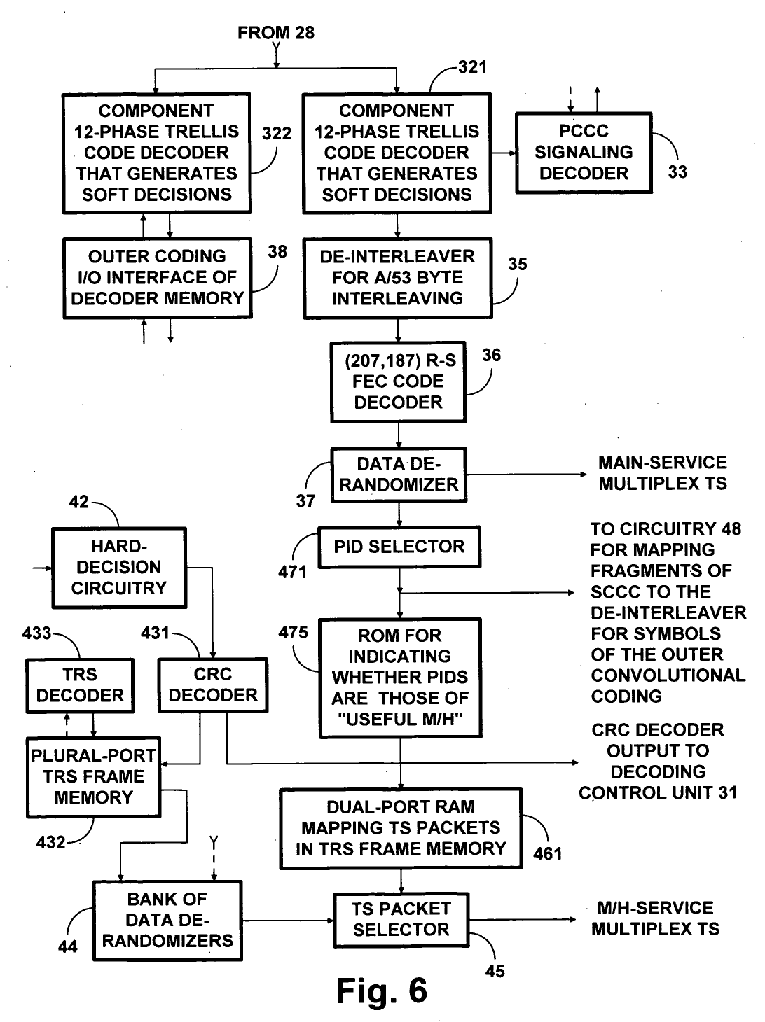

FIG. 6 shows details of portions of another embodiment of the FIG. 3 receiver apparatus that differs from the FIG. 4 embodiment in the following respects. The comparator 472, the list scanner 473 and the latch 474 of the FIG. 4 embodiment are not present in the FIG. 6 embodiment. Instead, the PID selector 471 is connected for supplying each successive PID that it selects to read-only memory 475 as read addressing thereof. FIG. 6 shows the random-access memory 323 connected for being written with the digital filtering 28 response. The RAM 323 is operated for delaying the digital filtering 28 response supplied as input signal to the component 12-phase trellis decoder 322. The delay compensates for the latent delay in the path through the byte interleaver 35, the R-S decoder 36, the data de-randomizer 37, the PID selector 471 and so forth. This delay permits the PIDs selected by the PID selector 471 to be supplied in time to circuitry 323 for mapping fragments of turbo coding for application as input signal to the symbol de-interleaver for the outer convolutional coding of the SCCC.

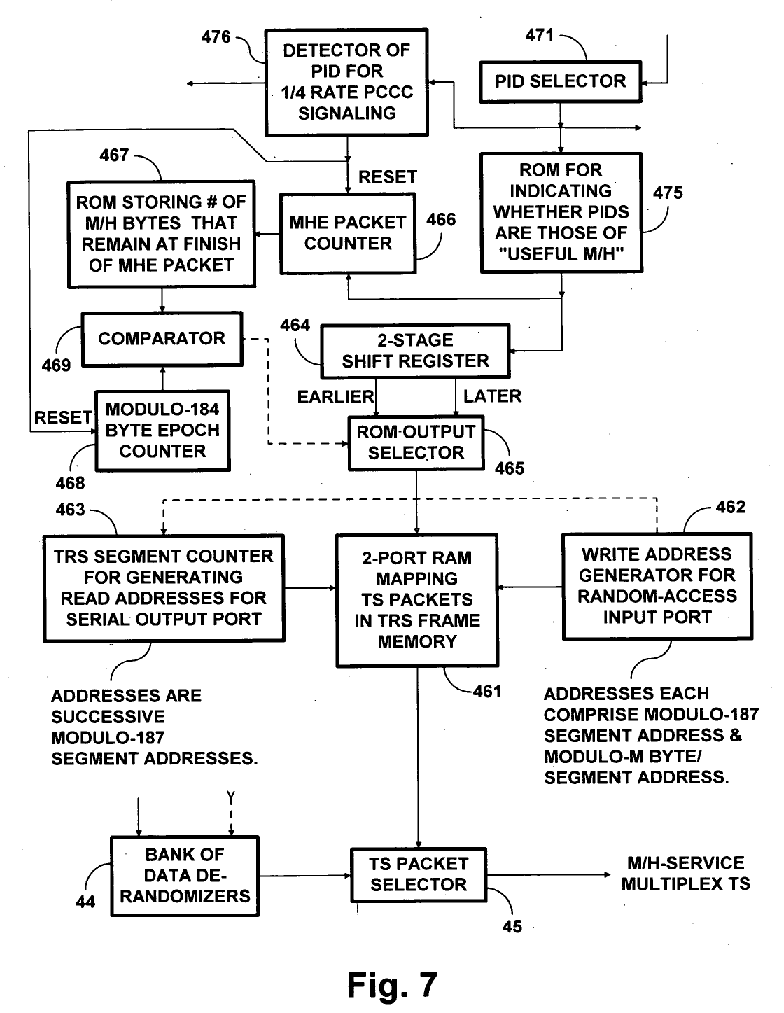

FIG. 7 shows details of the FIG. 6 DTV receiver relating to the operation of the dual-port RAM 461 for mapping the packets in the TRS frame memory 432. A write address generator 462 generates write addresses composed of byte addressing and TRS segment addressing. The byte addressing is supplied by a modulo-M counter and corresponds with the M bytes in each row of the TRS frame. The TRS segment addressing is supplied by a modulo-187 counter that counts roll-overs from the modulo-M counter. The write address generator 462 is connected for applying these write addresses to the 2-port RAM 461 for controlling the writing of its storage locations with signal applied to its random-access port. A TRS segment counter 463 is another modulo-187 counter supplying a segment count retarded in phase from that of the modulo-187 counter in the write address generator 462. The read address generator 463 is connected for applying its segment count as read addresses to the 2-port RAM 461 for controlling the reading of M-bit sequences from its serial output port to the TS packet selector 45.

FIG. 7 shows the ROM 475 connected for supplying indications as to whether or not PIDs of M/H data that can be usefully received by the FIG. 6 receiver have been received, which indications are applied to a two-stage shift register 464 as input signal thereto. A ROM-output selector 465 is connected for selecting the contents of one of the two shift register 464 stages for application to the random-access port of the dual-port RAM 461. An MHE packet counter 466 is connected for counting indications from the ROM 475 that PIDs of M/H data that can be usefully received by the FIG. 6 receiver have been received. The counter 466 is connected for supplying the MHE packet count to read-only memory 467 as the read addressing thereof. The ROM 467 stores the number of bytes of an M/H packet that remain, or are left over, from the MHE packet corresponding to the previous ROM 467 read address. A byte epoch counter 468 cyclically counts the number of byte epochs modulo-184. A comparator 469 is connected for comparing the byte epoch count from the counter 468 with the number of bytes of an M/H packet that the ROM 467 indicates are left over from the previous MHE packet. The comparator 469 is connected for supplying comparison results to the ROM-output selector 465, as control signal that conditions reproduction of the contents of one of the two shift register 464 stages for application to the random-access port of the dual-port RAM 461.

A detector 476 for the a PID indicating the PCCC transmission of signaling is connected for receiving PIDs selected by the PID selector 471. The detector 476 responds with a logic ONE to an a PID indicating the PCCC transmission of signaling. The detector 476 responds with a logic ZERO to any other PID. The counter 466 is connected for being reset to its initial value of MHE packet count by a logic ONE response from the detector 476. A modulo-187 M/H byte counter 477 is connected for being reset to a byte count of one by a logic ONE response from the detector 476.

When the modulo-187 byte epoch count from the counter 468 is not larger than the number of bytes of an M/H packet that the ROM 467 indicates are left over from the previous M HE packet, the comparator 469 response is a logic ZERO. The logic ZERO response of the comparator 469 conditions the ROM-output selector 465 to reproduce the contents of the final one of the two shift register 464 stages for application to the random-access port of the dual-port RAM 461. That is, the next to last response of the ROM 475 is supplied to that random-access port.

When the modulo-187 byte epoch count from the counter 468 is larger than the number of bytes of an M/H packet that the ROM 467 indicates are left over from the previous MHE packet, the comparator 469 response is a logic ONE. The logic ONE response of the comparator 469 conditions the ROM-output selector 465 to reproduce the contents of the initial one of the two shift register 464 stages for application to the random-access port of the dual-port RAM 461. That is, the last response of the ROM 475 is supplied to that random-access port.

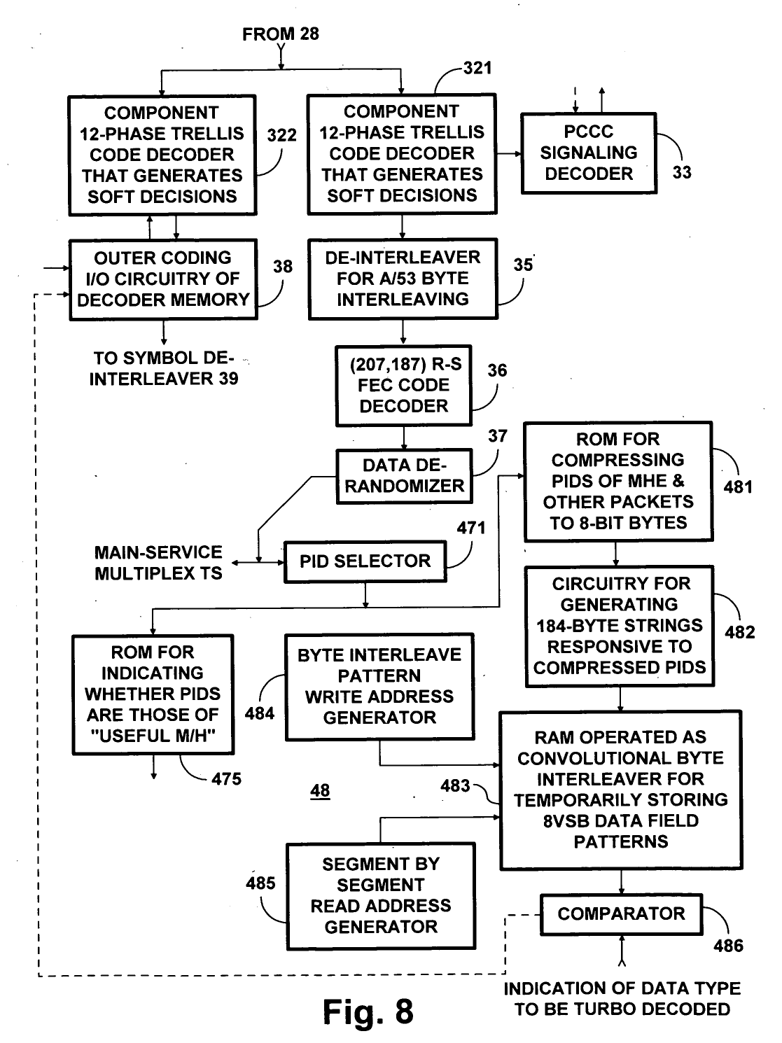

FIG. 8 shows details of the circuitry 48 for mapping fragments of turbo coding for application as input signal to the symbol de-interleaver for the outer convolutional coding of the SCCC. The circuitry 48 includes elements 481, 482, 483, 484, 485 and 486 connected as described infra. A read-only memory 481 is connected for receiving, as its read addressing, the PIDs selected by the PID selector 471. The ROM 481 responds to the 13-bit PIDs with 8-bit compressed PIDs in the response read therefrom to circuitry 482 for generating 184-byte strings responsive to those 8-bit compressed PIDs. Each successive 184-byte long string of 8-bit compressed PIDs is written to the random-access input/output port of a random-access memory 483 operated as a convolutional byte interleaver. The circuitry 482 is somewhat more complicated than a simple latch for each compressed PID generated by the ROM 481, which latch temporarily stores the compressed PID for 184 byte intervals as the RAM 483 is written. The occurrence of training signals and signaling with quarter-rate PCCC has to be taken into account. The fact that M/H packets are apt to have remaining bytes at the conclusion of the payload field of each MHE packet has to be taken into account also; this can be done using a technique similar to that described infra in regard to circuitry shown in FIG. 7. A write address generator 484 is connected for supplying the RAM 483 write addresses in accordance with the portion of the convolutional byte interleaving pattern including the payload fields of MHE packets. A read address generator 485 is connected for supplying the RAM 483 read addresses that govern the reading of byte-interleaved compressed PIDs from the RAM 483.

A comparator 486 is connected for comparing the byte-interleaved compressed PIDs from the RAM 483 with an indication of the type of data that has been selected for turbo decoding. When and only when the byte-interleaved compressed PIDs from the RAM 483 correspond to this indication, the comparator 486 generates a logic ONE as the comparison result. Otherwise, the comparator 486 generates a logic ZERO as the comparison result. These comparison results indicate when a fragment of SCCC appears in the baseband DTV signal supplied to the component 12-phase trellis decoder 321. The comparator 486 is connected for supplying the comparison results to the outer coding I/O interface 38 to the memory of the component decoder 321. The outer coding I/O interface 38 responds to the indications that the comparator 486 supplies concerning when fragments of SCCC appear for selectively forwarding these fragments to the symbol de-interleaver 39 as input signal thereto.

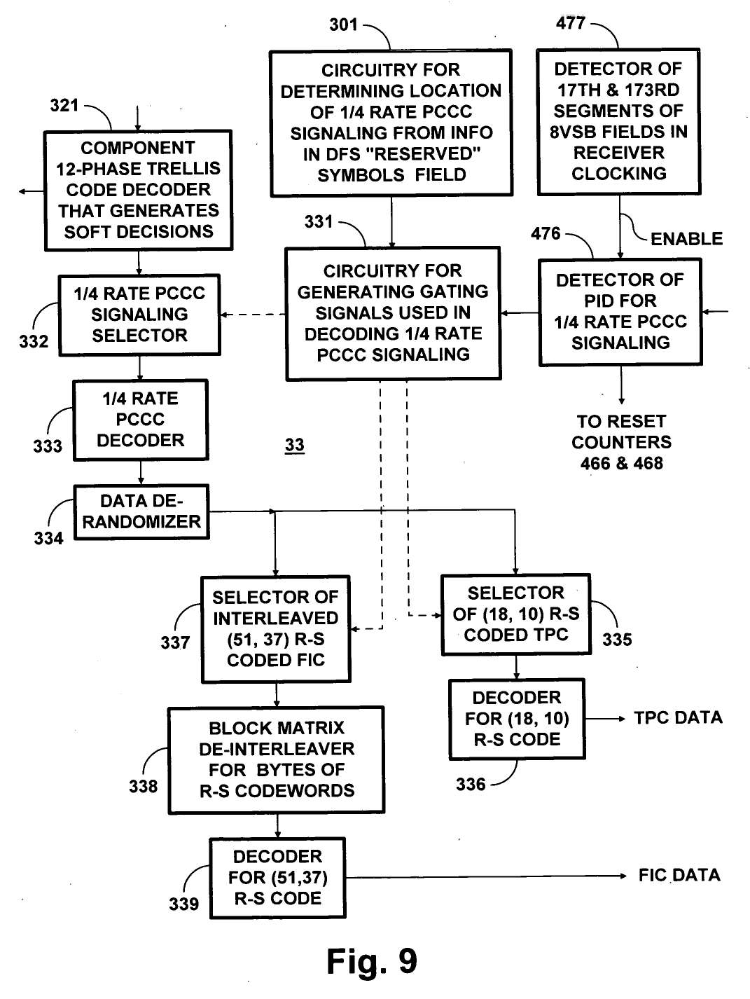

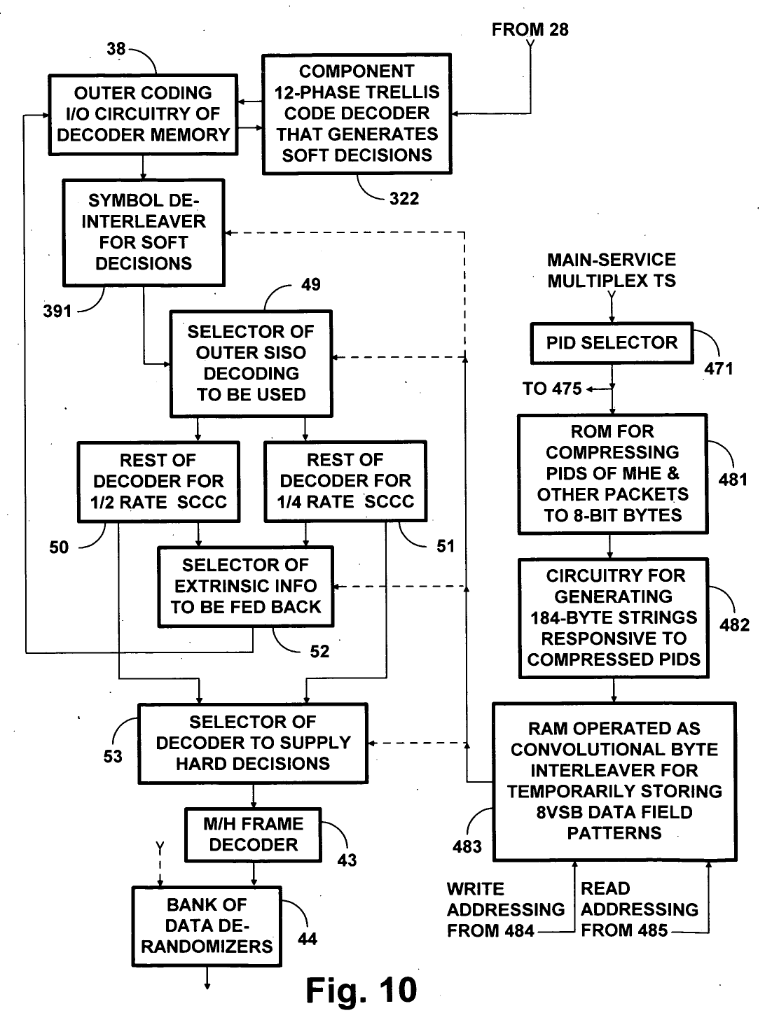

FIG. 9 shows details of the FIG. 6 DTV receiver relating to the operation of the PCC signaling decoder 33 comprising elements 331, 332, 333, 334, 335, 336, 337, 338, and 339. FIG. 10 shows a detector 477 for determining from a segment counter in the clocking circuitry of the receiver when the seventeenth and the one hundred seventy-third segments of 8-VSB data fields occur. The detector 477 is connected for supplying indications of when these events occur to the detector 476 as an enable signal. The detector 476 is conditioned for detecting the α PID only during the seventeenth and one hundred seventy-third segments of 8-VSB data fields. The α PID that indicates the PCCC transmission of signaling should occur only during the seventeenth or one hundred seventy-third segments of 8-VSB data fields. Accordingly, the likelihood of the detector 476 erroneously detecting the occurrence of the α PID is substantially reduced.

FIG. 9 shows circuitry 331 for generating gating signals used in decoding the quarter-rate PCCC signaling. FIG. 9 shows circuitry 301 for determining the location of quarter-rate PCCC signaling within 8-VSB data fields, proceeding from information conveyed by specified symbols in the “reserved” symbol fields of DFS signals. The circuitry 301 is connected for supplying the circuitry 331 with indications of whether the quarter-rate PCCC signaling begins in the seventeenth or one hundred seventy-third segment of each 8-VSB data field. In addition to this previously known practice, the detector 476 of the α PID that indicates the PCCC transmission of signaling is connected for supplying the circuitry 331 with further indications of when quarter-rate PCCC signaling begins. In accordance with an aspect of the invention, these further indications facilitate the circuitry 331 generating the gating signals used in decoding the quarter-rate PCCC signaling when symbols in the “reserved” symbol fields of DFS signals are corrupted by noise.

FIG. 9 shows a selector 332 connected for selectively reproducing the output signal from the component 12-phase trellis decoder 321, selection being controlled by gating signal supplied from the circuitry 331. The selector 332 is further connected for supplying the quarter-rate PCCC signaling it reproduces to be applied as input signal to a decoder 333 for quarter-rate PCCC. The decoder 333 is connected for supplying the randomized binary signaling data that it decodes to a data de-randomizer 334 as input signal thereto.

A selector 335 controlled by gating signal supplied from the circuitry 331 reproduces only the (18, 10) Reed-Solomon codewords in the de-randomized binary signaling data that the data de-randomizer 334 supplies as its response. A decoder 336 for (18, 10) Reed-Solomon code is connected for decoding the (18, 10) R-S codewords reproduced by the selector 335, thereby recovering transmission parameter channel (TPC) data for use by the receiver.

A selector 337 controlled by gating signal supplied from the circuitry 331 reproduces only 51-byte sequences of byte-interleaved (51, 37) Reed-Solomon codewords in the de-randomized binary signaling data that the data de-randomizer 334 supplies as its response. The selector 337 is connected for supplying these selectively reproduced 51-byte sequences to a matrix type block de-interleaver 338 for the bytes. A decoder 339 for (51, 37) Reed-Solomon code is connected for decoding the (51, 37) Reed-Solomon codewords reproduced in the response of the de-interleaver 338, thereby recovering fast information channel (FIC) data for use by later stages of the receiver.

FIG. 10 shows in greater detail how one can arrange for the controlling the use different rates of outer convolutional coding in accordance with an aspect of the invention. FIG. 10 presumes that the same symbol interleaver 391 for soft decisions from the component trellis code decoder 322 is used both for SCCC using half-rate outer convolutional coding and for SCCC using quarter-rate outer convolutional coding. As currently conceived, the M/H standard will provide for different types of symbol interleaving. Accordingly, indications read from the RAM 483, which indicate the type of M/H encoding being currently received are supplied to the symbol interleaver 391. The symbol interleaver 391 comprises a plurality of different block interleavers and selection circuitry for selecting one those block interleavers responsive to indication of the type of M/H encoding being currently received.

A selector 49 is connected for selecting interleaved soft decisions concerning the inner convolutional coding, as supplied from the symbol interleaver 391, for reproduction as input signal to the rest 50 of a decoder for SCCC of one half the rate of ordinary 8VSB, or for reproduction as input signal to the rest 51 of a decoder for SCCC of one quarter the rate of ordinary 8VSB. This selection is controlled by the indications of the type of M/H encoding being currently received, as read from the RAM 483. Those same indications control a selector 52 connected for feeding back extrinsic information from the selected outer convolutional decoder to the component trellis code decoder 322 via its I/O interface 38. Those same indications also control a selector 53 connected for supplying hard decisions from the selected outer convolutional decoder to the M/H frame decoder 43 as input signal thereto.

More particularly, the selector 52 is connected for reproducing extrinsic information from the rest 50 of the decoder for SCCC of one half the rate of ordinary 8VSB when indications read from the RAM 483 to the selector 52 as control signal thereto indicate that SCCC of one half the rate of ordinary 8VSB is currently being received. The selector 52 is further connected for reproducing extrinsic information from the rest 51 of the decoder for SCCC of one quarter the rate of ordinary 8VSB when indications read from the RAM 483 indicate that SCCC of one quarter the rate of ordinary 8VSB is currently being received.

Also more particularly, the selector 53 is connected for reproducing hard decisions from the rest 50 of the decoder for SCCC of one half the rate of ordinary 8VSB when indications read from the RAM 483 to the selector 53 as control signal thereto indicate that SCCC of one half the rate of ordinary 8VSB is currently being received. The selector 53 is further connected for reproducing hard decisions from the rest 51 of the decoder for SCCC of one quarter the rate of ordinary 8VSB when indications read from the RAM 483 indicate that SCCC of one quarter the rate of ordinary 8VSB is currently being received.

The invention can provide valuable back up for procedures specified in earlier versions of the M/H Standard. In these earlier versions M/H transmissions are signaled by one of the eight 8-VSB symbols just before the final twelve 8-VSB symbols of the data-field synchronization (DFS) segments. Indication of M/H transmission conditions M/H receivers to detect further information in still earlier of the reserved symbols in DFS segments concerning whether more complete M/H signaling information occurs. These earlier reserved symbols indicate whether the quarter-rate PCCC signaling begins in the seventeenth or one hundred seventy-third segment of each 8-VSB data field. The symbols in DFS segments that relate to M/H transmission are susceptible to corruption by burst noise, particularly the streaky kind that is generated by arc-over in the motors of small electrical appliances. So is the quarter-rate PCCC signaling in the 17th and 18th segments of some 8-VSB data fields and in the 123d and 174th segments of other 8-VSB data fields. The signaling can be repeated a number of times prior to a particular form of SCCC being transmitted, but this is not helpful soon after a channel change and may also be inadequate soon after a protracted fade in received signal strength.

The 118 packets in an M/H group are supposed to provide the same quality of service. So if the PIDs of the MHE packets signal the M/H code rate and symbol interleaving, most of them within the same group will have similar PIDs. These PIDs are spread out by 207 byte epochs or so in the byte-interleaved 8-VSB data fields that modulate the radio-frequency signals broadcast over the air. This reduces the likelihood of most of these PIDs being corrupted by burst noise. Since there are a number of similar value PIDs, correlation techniques can be used to determine their correct value despite a few of them being corrupted by noise.

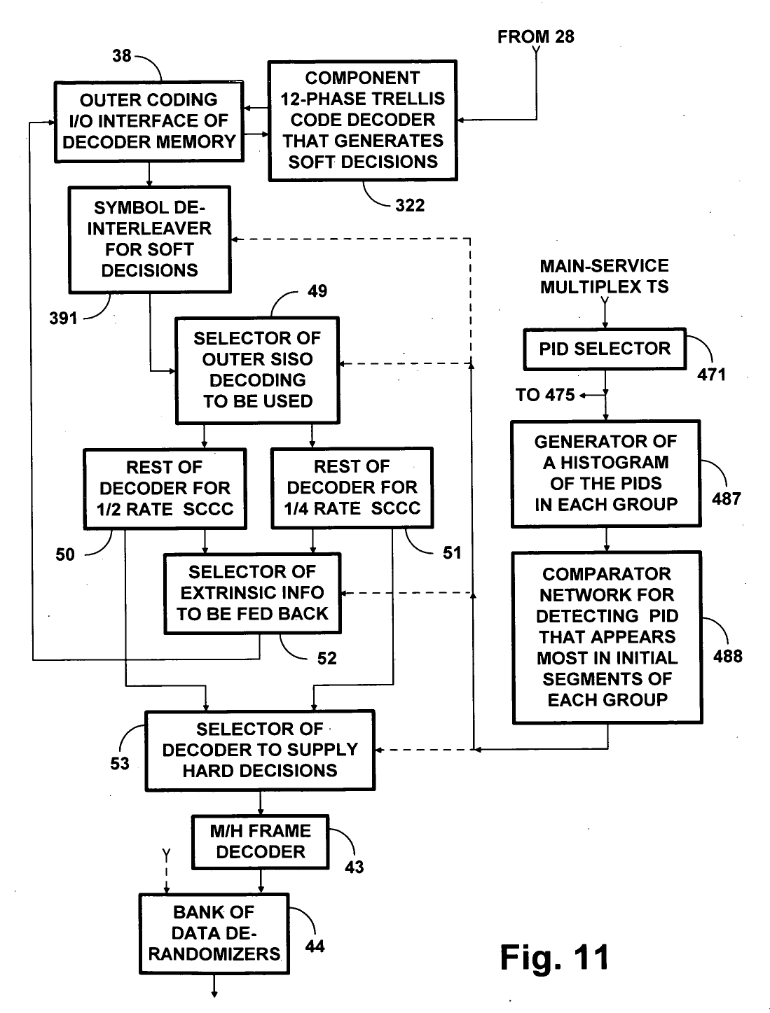

FIG. 11 shows a way this is done in a variant of the FIG. 10 portion of the FIG. 6 embodiment of the FIG. 3 DTV receiver apparatus. The FIG. 11 apparatus does not use the elements 481, 482, 483, 484, 485 and 486 that appear in the apparatuses of FIGS. 8 and 10. FIG. 11 shows the PID selector 471 connected for supplying PIDs to a generator 487 of a histogram of the PIDs in each successive group of M/H packets. The generator 487 comprises a respective detector for each PID of concern and a respective counter for counting how many times that PID is detected within a successive group of M/H packets. A comparator network 488 is connected for responding to the histogram presented thereto from the generator 487 to select the PID appearing the most times in the initial segments of each successive group of M/H packets. The number of times the PID must appear before it is accepted as the valid PID value may be varied according to perceived SNR of the received signal. That SNR may be perceived from the relative strengths of the counts in the histogram. When a valid PID value is determined, it is used for controlling selections by the selectors 49, 52 and 53.

As noted in the “Background of the Invention” supra some participants in the ATSC have expressed their reluctance to reserve a large number of PIDs for use in identifying MHE packets of different types. Responsive to such reluctance, the inventor reformulated the aspect of his invention concerning the identification of MHE packets of different types, as follows. A new PID for MHE packets is introduced only when the M/H Standard is updated to introduce a major change in the procedures for decoding the M/H signals and converting them to the internet protocol (IP) used in later stages of M/H reception. Changes in the procedures for decoding the IP are signaled in the headers of the IP packets without requiring a new PID for MHE packets. Some components of the M/H signal per an updated M/H Broadcast Standard may be usefully received by DTV receivers designed for receiving signals of an earlier M/H Broadcast Standard. Such components are transmitted in MHE packets with PIDs as specified by the earliest M/H Broadcast Standard employing those components. In the reformulated invention the specifics of those components are not signaled in the 13-bit PIDs within the 3-byte headers of the 187-byte MHE packets, however, but rather in other bits of those headers.

The initial bit of each of these 3-byte headers is preferably kept ZERO, so its function as a transport error indicator (TEI) bit for (207, 187) lateral Reed-Solomon coding is not impaired. This facilitates receiver designs in which bytes in the M/H data that are less likely to be in error are flagged based on the results of decoding (207, 187) lateral R-S codewords. The ten bits of the 3-byte header of each 187-byte MHE packet, other than its initial bit and the 13-bit PID, are available for specifying the natures of the turbo encoding and RS Frame encoding used in the M/H data encapsulated in the 184-byte payload data field of that MHE packet. The exact assignment of each of these ten bits to a particular function is arbitrary, of course. Rather than the ten bits or particular groups of those bits relating to respective functions, the bits may be used in ten-bit coding in which each codeword relates to a combination of functions producing a favorable result overall.

Embodiments of the invention alternative to those as thusfar described in this “Detailed Description” have been implemented in the Candidate Standard:ATSC-M/H Standard being published on 31 Dec. 2008 and its updates. Rather than the information concerning which version of the M/H Standard is used in transmitting each M/H Group being placed in the headers of the data segments within each M/H Group, version information is included within the TPC and FIC signaling. This alternative arrangement complicates intermixing transmissions in accordance with different versions of the M/H Standard within the same M/H Frame, however.

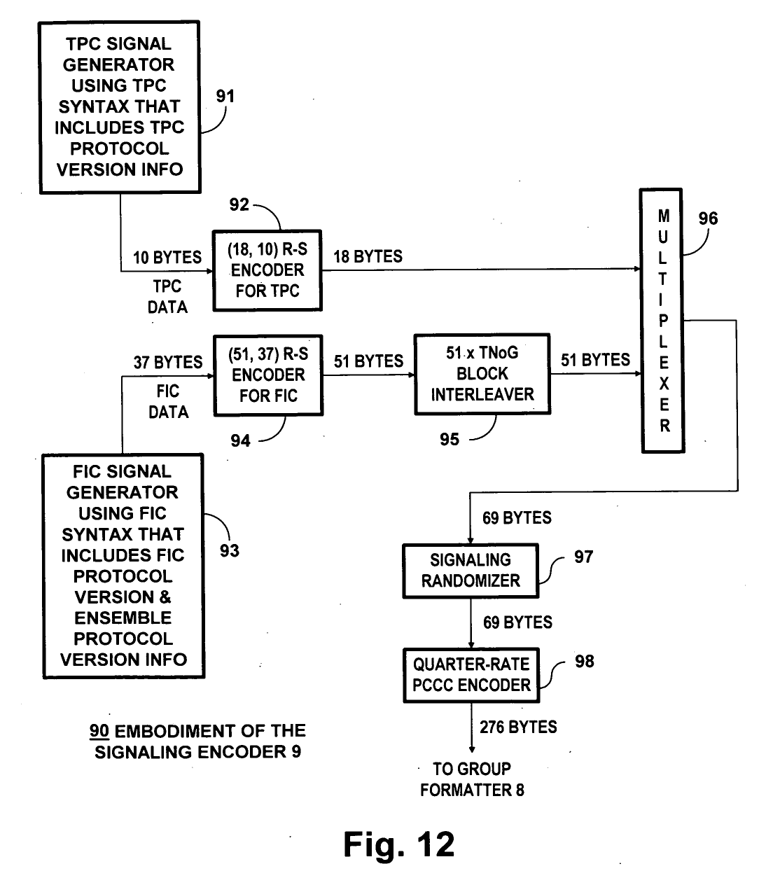

FIG. 12 shows an embodiment 90 of the signaling encoder 9 in FIG. 1 DTV transmitter apparatus, as modified to incorporates version information within the TPC and FIC signaling. The signaling encoder 90 comprises a TPC signal generator 91 and an encoder 92 for (18, 10) Reed-Solomon coding TPC bits supplied by the TPC signal generator 91. The syntax for each 10-byte TPC signal generated by the TPC signal generator 91 includes TPC_protocol_version code to provide version information in accordance with an aspect of the invention. The signaling encoder 90 comprises an FIC signal generator 93 and an encoder 94 for (51, 37) Reed-Solomon coding FIC bits supplied by the FIC signal generator 93. Each FIC-Chunk of the FIC signal generated by the FIC signal generator 93 includes both ensemble_protocol_version code for each ensemble in the FIC-Chunk payload and FIC_protocol_version code in the FIC-Chunk header to provide version information in accordance with an aspect of the invention. The encoder 94 encodes thirty-seven bytes per Group and is connected for supplying the resulting 51 bytes of RS-coded FIC to a matrix-type block interleaver 95. A time-division multiplexer 96 is connected for supplying a response that interleaves 51 bytes of block interleaver 95 response as received at a first input port of the multiplexer 96 between each 18-byte RS codeword received from the encoder 92 at a second input of the multiplexer 96. The multiplexer 96 is connected for supplying its response to a signaling randomizer 97. The signaling randomizer 97 is connected for supplying its response as input signal to a quarter-rate PCCC encoder 98, which is in turn connected to supply the quarter-rate PCCC that it generates to the Group formatter 8.

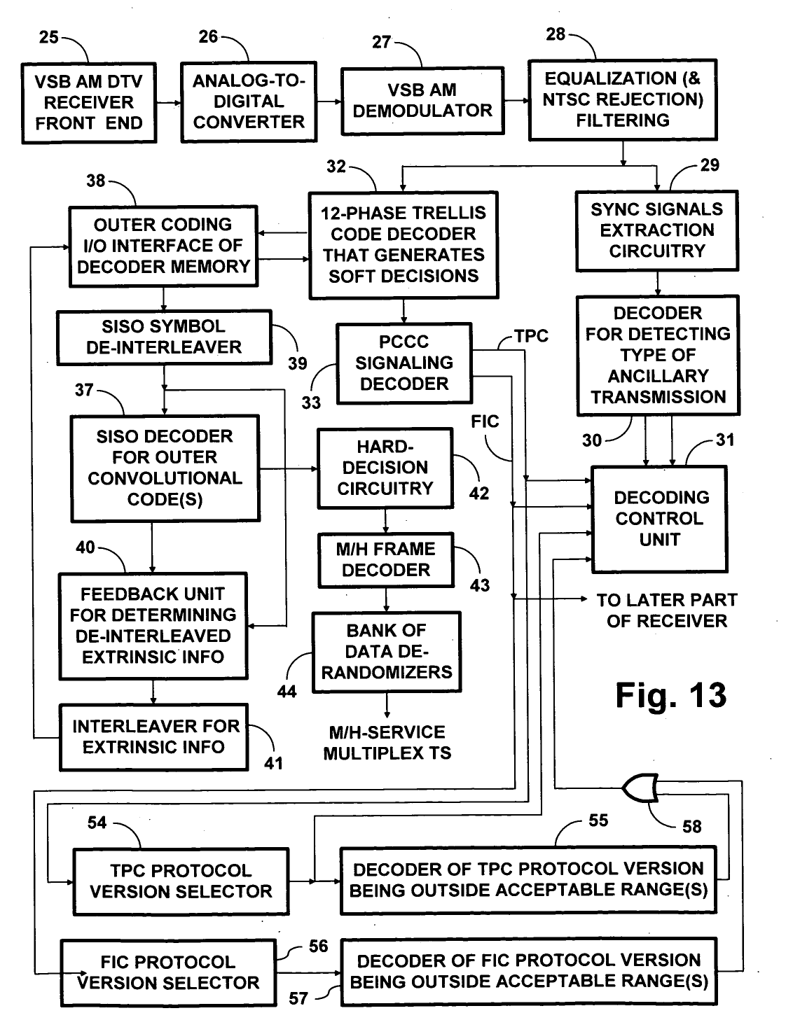

FIG. 13 shows M/H receiver apparatus that is a modification of that which FIG. 3 shows. The de-interleaver 34, the decoder 35 for (207, 187) RS FEC code and the data de-randomizer 36 are omitted from the FIG. 13 receiver apparatus. The TS packet selector 45 is replaced by a continuous output connection in the FIG. 13 M/H receiver apparatus. So, the mapper 46 for mapping useful TS packets and the detector 47 of useful MHE packet PIDs, used in the FIG. 3 receiver apparatus to develop control signal for the TS packet selector 45, are not included in the FIG. 13 receiver apparatus.

The FIG. 13 M/H receiver apparatus is designed for receiving M/H signals transmitted by modified FIG. 1 transmitter apparatus in which the signaling encoder 9 is of the type shown in FIG. 12. That is, the TPC and FIC signals include version information concerning which version of the M/H standard is complied with when transmitting the accompanying M/H signal. The PCCC signaling decoder 33 is connected to supply TPC and FIC signals to the decoding control unit 31, which connections are similar to those employed in the FIG. 3 apparatus although shown in less detail in FIG. 3 than in FIG. 13.

In the FIG. 13 receiver apparatus, the PCCC signaling decoder 33 is further connected to supply TPC signal as input signal to a TPC protocol version selector 54. The selector 54 selects the TPC_protocol_version code from the TPC signal associated with each M/H Group, for application both to the decoding control unit 31 as one of the input signals thereto and to a decoder 55 as the input signal thereto. The decoder 55 responds with a ZERO if and only if the TPC_protocol_version code is in an acceptable range therefor—that is, of a value associated with a TPC protocol that the FIG. 13 receiver apparatus is equipped to use successfully. The decoder 55 responds with a ONE if the TPC_protocol_version code is of a value not within an acceptable range—that is, of a value associated with a version of the M/H standard that the FIG. 13 receiver apparatus is not equipped to use successfully or is not known to be so equipped.

In the FIG. 13 receiver apparatus, the PCCC signaling decoder 33 is further connected to supply successive FIC-Chunks as input signal to an FIC protocol version selector 56. The selector 56 selects the FIC_protocol_version code from the header of each FIC-Chunk for application to a decoder 57 as input signals thereto. The decoder 57 responds with a ZERO in regard to each ensemble if and only if the FIC_protocol_version code is in an acceptable range for the FIG. 13 receiver apparatus—that is, of a value associated with an FIC protocol that the FIG. 13 receiver apparatus is equipped to use successfully. The decoder 55 responds with a ONE if the FIC_protocol_version code is of a value not within an acceptable range for the FIG. 13 receiver apparatus. That is, if the value of the FIC_protocol_version code is of a value associated with an FIC protocol that the FIG. 13 receiver apparatus is not equipped to use successfully or is not known to be so equipped.

FIG. 13 shows a two-input OR gate 58 connected for receiving the responses of the decoders 55 and 57 at its first and second input connections and for applying its response to the decoding control unit 31 as a further input control signal thereof. (The decoders 55 and 57 are constructed for taking into account the advanced signaling of TPC and FIC signals.) The response of the OR gate 58 is applied to the decoding control unit 31 as a supplementary control signal. If the TPC_protocol_version and FIC_protocol_version codes are both within their respective acceptable ranges for an M/H Ensemble, the response of the OR gate 58 is a ZERO in regard to that M/H Ensemble. Application of this ZERO to the decoding control unit 31 as the supplementary control signal conditions the decoding control unit 31 to respond to commands within the TPC signals that direct the turbo decoding and RS Frame decoding of that M/H Ensemble. These commands are interpreted according to the TPC protocol specified by the bits that the TPC protocol version selector 54 selects as input signal to the decoding control unit 31. The decoding control unit 31 permits the M/H service multiplex transport stream to be supplied from the bank 44 of data de-randomizers to the remaining portion of the M/H receiver.

If either the TPC_protocol_version or the FIC_protocol_version is not within its respective acceptable range for an M/H Ensemble, the response of the OR gate 58 is a ONE in regard to that M/H Ensemble. Application of this ONE to the decoding control unit 31 as the supplementary control signal conditions the decoding control unit 31 to forestall M/H service multiplex transport stream being supplied from the bank 44 of data de-randomizers to the remaining portion of the M/H receiver. This can be accomplished in a variety of ways, as one skilled in the art will appreciate. For example, the decoding control unit 31 can be arranged to prevent turbo decoding and RS Frame decoding of an M/H Ensemble responsive to the supplementary control signal supplied from the OR gate 58 being a ONE. If such an arrangement is used, the bank 44 of data de-randomizers can have a hard-wired connection to the remaining portion of the M/H receiver, rather than being selectively so connected via the TS packet selector 45. That is, the M/H receiver does not include the TS packet selector 45 when such arrangement is used. Alternatively, the TS packet selector 45 can be retained for selectively connecting the bank 44 of data de-randomizers connects to the remaining portion of the M/H receiver, and the decoding control unit 31 may transfer the OR gate 58 response with suitable delay to the TS packet selector 45 as control signal therefore. This alternative is not preferred, however, especially if turbo decoding and RS Frame decoding of the M/H Ensemble is not discontinued so as to conserve operating power.

The decoding control unit 31 is connected for responding to the TPC_protocol_version bits that the selector 54 selects from each said sequence of decoded TPC signal. The decoding control unit 31 is capable of determining whether or not the value of those selected bits is or is not one acceptable for continuing decoding operations within the FIG. 13 receiver apparatus in regard to the coded M/H data in the respective M/H Parade to which the currently received sequence of decoded TPC signal pertains. FIG. 13 shows this determination being communicated through the agency of the decoder 55 and AND gate 58, but alternatively this determination can be made more directly in a portion of the decoding control unit 31 itself. If the value of those selected bits is not one acceptable for continuing decoding operations within the FIG. 13 receiver apparatus in regard to the coded M/H data in the respective M/H Parade to which the currently received sequence of decoded TPC signal pertains, the decoding control unit 31 directs the cessation of such decoding operations. If the value of those selected bits is one acceptable for continuing decoding operations within the FIG. 13 receiver apparatus in regard to that coded M/H data, the decoding control unit 31 interprets the commands contained in remaining bits of that the currently received sequence of TPC signal as specified by the bits of the TPC protocol version from the selector 54 and controls the decoding operations of the FIG. 13 receiver apparatus according to those commands as so interpreted.

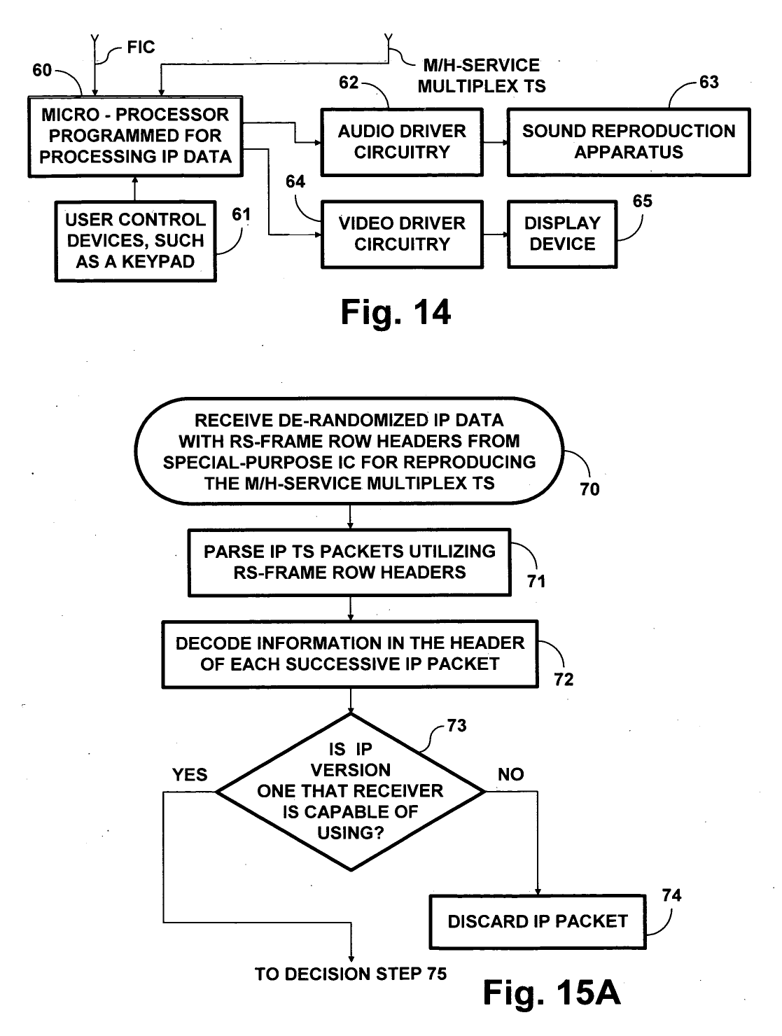

FIG. 14 shows further receiver apparatus that typically follows the receiver apparatus of FIG. 3, of FIGS. 3 and 4, of FIGS. 3 and 6, or of FIG. 13, as well as variants of those specific receiver apparatuses. The receiver apparatus of FIG. 3, of FIGS. 3 and 4, of FIGS. 3 and 6, or of FIG. 13, as well as variants of those specific receiver apparatuses is generally constructed as a special-purpose integrated circuit in present-day M/H signal receivers. A general-purpose micro-processor 60 is connected for receiving as an input signal thereto the M/H-service multiplex transport stream reproduced by the bank 44 of data de-randomizers in such a special-purpose integrated circuit. The micro-processor 60 is further connected for receiving control input signals from user control devices 61, such as the switches in a keypad. The micro-processor 60 is programmed to process compressed audio signal(s) extracted from the M/H-service multiplex transport stream and is connected for supplying the processed audio signal(s) to audio driver circuitry 62 as its audio input signal. The audio driver circuitry 62 responds to its input signal to supply audio driver signal(s) to sound reproduction apparatus 63. The micro-processor 60 is programmed to process compressed video signal(s) extracted from the M/H-service multiplex transport stream and is connected for selectively supplying the processed video signal(s) to video driver circuitry 64 as its video input signal. The micro-processor 60 is programmed to process tabular information extracted from the M/H-service multiplex transport stream, constructing video signal therefrom for selectively supplying the video driver circuitry 64 its video-input signal. One or more of the user control devices 61 controls the selection of the video input signal to be supplied to the video driver circuitry 64. The video driver circuitry 64 responds to its input signal to supply video driver signal(s) to display device 65. In accordance with an aspect of the invention, the micro-processor 60 is programmed not to respond to M/H transmissions that comply with versions of the M/H standard that the further receiver apparatus of FIG. 14 is incapable of usefully receiving.

FIG. 14 shows the micro-processor 60 connected for receiving FIC signal. This FIC signal is in the form of FIC-Chunks from the PCCC signaling decoder 33 of FIG. 3, of FIGS. 3 and 4, of FIGS. 3 and 6, or of FIG. 13, for example. In some designs the micro-processor 60 is programmed to analyze the ensemble protocol version codes in the payload portions of the FIC-Chunks. This is done in accordance with an aspect of the invention for determining on an individual basis whether M/H ensembles were transmitted in accordance with a version of the M/H Standard that the micro-processor 60 is programmed to process successfully.

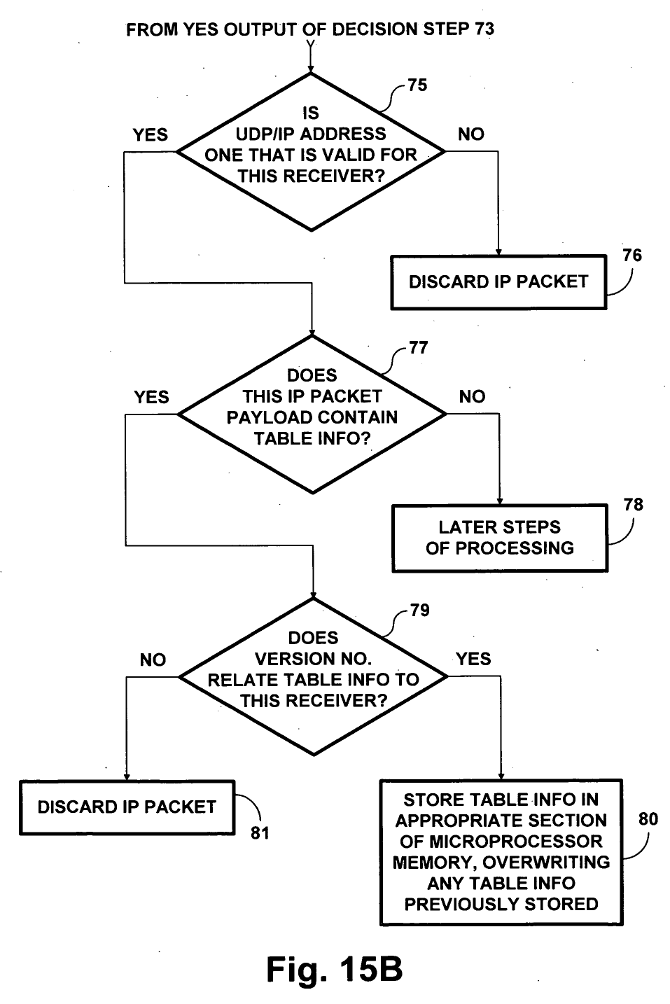

FIGS. 15A and 15B combine to provide a flow chart illustrating the method in which packets of M/H information that can be usefully received by the receiver are selected for complete processing in the micro-processor 60. FIG. 15A shows the beginning of this flow chart beginning with an initial step 70 of the method. In step 70 de-randomized IP data with RS-Frame row headers is received from the special-purpose integrated circuitry used for reproducing the M/H-service multiplex transport stream.

The step 70 is followed by a step 71 in which the IP-transport-stream packets are parsed, utilizing indications in each RS Frame row header as to when an IP-transport-stream packet starts within that RS Frame row. The step 71 is followed by a step 72 in which information contained the header of each successive IP-transport-stream packet is decoded. The step 71 is followed by a decision step 73 for deciding whether or not the internet protocol version specified in the respective header of each successive IP-transport-stream packet (or selected ones of them) is one that the receiver is capable of usefully receiving. That is, more particularly, whether the IP version is one that the micro-processor 60 is programmed to process appropriately. If the internet protocol version specified in the respective header of each successive IP-transport-stream packet (or selected ones of them) is not one that the receiver is capable of usefully receiving, that IP-transport-stream packet is discarded in a step 74 of the method. If the internet protocol version specified in the respective header of each successive IP-transport-stream packet (or selected ones of them) is one that the receiver is capable of usefully receiving, that IP-transport-stream packet and its attendant header information progress to a decision step 75 shown in FIG. 15B. If no internet protocol version is specified in the respective header of an IP-transport-stream packet, that IP-transport-stream packet and its attendant header information also progress to a decision step 75 shown in FIG. 15B.

The decision to be made in step 75 is whether or not the UDP/IP address specified in the respective header of each successive IP-transport-stream packet is one that is valid for the receiver. (UDP is the acronym for Universal Data Protocol, and the IP-transport-stream packets in this protocol are often referred to as datagrams.) That is, more particularly, whether the UDP/IP address is within the range of UDP/IP addresses that the micro-processor 60 is capable of processing appropriately. If the UDP/IP address specified in the respective header of each successive IP-transport-stream packet is not one within the range of UDP/IP addresses that the micro-processor 60 is capable of processing appropriately, the decision in step 75 is that the UDP/IP address is not valid for the receiver. Consequently, that IP-transport-stream packet that is not valid for the receiver is discarded in a step 76 of the method. If the UDP/IP address specified in the respective header of each successive IP-transport-stream packet is one within the range of UDP/IP addresses that the micro-processor 60 is capable of processing appropriately, the decision in step 75 is that the UDP/IP address is valid for the receiver. If the UDP/IP address is valid for the receiver, that IP-transport-stream packet and its attendant header information progress to a decision step 77 shown in FIG. 15B.

The decision to be made in step 77 is whether or not the respective payload of each successive IP-transport-stream packet contains table information. This may be deduced from the UDP/IP address. If information in the header of an IP-transport-stream packet indicates that the packet payload does not contain table information, the IP-transport-stream packet is forwarded to appropriate later steps 78 of processing within the micro-processor 60. The performance of these later steps 78 of processing within the micro-processor 60 are apt to be controlled by the table information contained in other IP-transport-stream packets. If information in the header of an IP-transport-stream packet indicates that the packet payload does contain table information, the IP-transport-stream packet and its attendant header information progress to a decision step 79 shown in FIG. 15B.

The decision to be made in step 79 is whether or not each successive IP-transport-stream packet that contains table information in its respective payload was transmitted so as to comply with a version of the M/H Standard that transmits table information useful to the receiver. If the version of the M/H Standard specified within the header of such an IP-transport-stream packet is not within the range of versions of the M/H Standard that supply table information useful to the receiver, that IP-transport-stream packet is discarded in a subsequent step 80 of the method.

On the other hand, it may be decided in the step 79 that the version of the M/H Standard specified within the header of such an IP-transport-stream packet is within the range of versions of the M/H Standard that supply table information useful to the receiver. In such case, in a subsequent step 80 of the method, the IP-transport-stream packet containing the useful table information is stored within an appropriate section of micro-processor 60 memory, over-writing any table information previously stored within that section of micro-processor 60 memory.

The foregoing description of the method in which packets of M/H information that can be usefully received by the receiver are selected for complete processing in the micro-processor 60 is simplified somewhat to keep the length of the flow chart shown in FIGS. 15A and 15B reasonably short and to avoid boring the reader with excessive detail. The simple decision step 77 shown in FIG. 15B will in actual practice be replaced by a succession of respective decision steps 77 for each specific type of table information entertained by the receiver. The YES response to each of these decision steps 77 will go to its own respective set of steps 79, 80 and 81. The NO response to each of these decision steps 77 except the final one will go to the next of the succession of respective decision steps 77. The NO response of the final one of these decision steps 77 is indicative that the packet payload apparently does not contain table information entertained by the receiver. Consequently, the IP-transport-stream packet is forwarded to appropriate later steps 78 of processing within the micro-processor 60.

In a variant of the above-described method for selecting which packets of M/H information can be usefully received by the receiver and will be completely processed by the micro-processor 60, the version information may be included in prefixes to the IP packets rather than within the headers of the IP packets per se. The version information may be included in the RS-Frame row headers, for example. Other variants of this aspect of the invention are apt readily to occur to persons familiar with the design of data-processing protocols and acquainted with this disclosure. Those variants that are alternative embodiments of the invention, as specifically described above, will embrace the following precept of the inventor. IP packets will not be fully processed by an M/H receiver if they contain or are individually accompanied by respective version information that indicates those IP packets were transmitted according to a version of the M/H Standard that the receiver does not know it is equipped for successfully receiving.

In the claims that follow, the word “said” is used to indicate the existence of preceding antecedent basis rather than the word “the”, the word “the” being reserved to the other uses of that word in the English language.

What is claimed is:

1. Apparatus for transmitting digital data in 8VSB signal form, at least part of which digital data comprises M/H data coded for transmission in robust form for reception by mobile receivers or other portable receivers, said M/H data as so coded encapsulated within payload portions of MPEG-2-compliant packets referred to as MHE packets that are Reed-Solomon coded and convolutionally byte interleaved before being ⅔ trellis coded, each M/H Group in each M/H Frame including respective amounts of said M/H data accompanied by sequences of training signal and by header information in the form of a sequence of Transmission Parameter Channel (TPC) signaling and a sequence of Fast Information Channel (FIC) signaling, said apparatus for transmitting digital data in 8VSB signal form being combined with an improvement comprising:
apparatus for including version information within each of prescribed portions of said M/H data, said prescribed portions of said M/H data being in addition to any portion of said M/H data descriptive of an electronic service guide (ESG) for advising a human user with regard to the content of said digital data transmitted in 8VSB signal form, said version information concerning the version of M/H broadcast standard used for transmitting that prescribed portion of said M/H data.

2. Apparatus for transmitting digital data in 8VSB signal form as set forth in claim 1, wherein said prescribed portions of said M/H data are respective M/H Groups of said M/H data.

3. Apparatus for transmitting digital data in 8VSB signal form as set forth in claim 2, wherein said apparatus for including version information within each of prescribed portions of said M/H data comprises:
apparatus for installing a particular one of a set of prescribed PIDs into headers of said MHE packets in each of said respective M/H Groups of said M/H data, each of said prescribed PIDs providing version information concerning the version of M/H broadcast standard used for transmitting the specific one of said respective M/H Groups of said M/H data including that particular one of said prescribed PIDs in said headers of said MHE packets included therewithin.

4. Apparatus for transmitting digital data in 8VSB signal form as set forth in claim 2, wherein said apparatus for including respective additional header information with each of prescribed portions of said M/H data inserts version information concerning the version of M/H broadcast standard used for transmitting each of said respective M/H Groups of said M/H data into the respective sequence of Transmission Parameter Channel signaling included within that said respective M/H Group.

5. Apparatus for transmitting digital data in 8VSB signal form as set forth in claim 1, wherein said prescribed portions of said M/H data are respective transfer stream packets of said M/H data, wherein each of said transfer stream packets begins with a respective header, and wherein said apparatus for including respective additional header information with each of prescribed portions of said M/H data inserts within the header of at least selected ones of said transfer stream packets respective version information concerning the version of M/H broadcast standard used for transmitting that one of said transfer stream packets.

6. Apparatus for transmitting digital data in 8VSB signal form as set forth in claim 1, wherein said prescribed portions of said M/H data are respective internet protocol (IP) packets of said M/H data, wherein each of said IP packets begins with a respective header, and wherein said apparatus for including respective additional header information with each of prescribed portions of said M/H data inserts within the header of at least selected ones of said IP packets respective version information concerning the version of M/H broadcast standard used for transmitting that one of said IP packets.

7. Receiver apparatus for receiving digital data in 8VSB signal form, at least part of which digital data comprises M/H data coded for transmission in robust form for reception by mobile receivers or other portable receivers, said M/H data as so coded encapsulated within payload portions of MPEG-2-compliant packets referred to as MHE packets that are Reed-Solomon coded and convolutionally byte interleaved before being ⅔ trellis coded, each M/H Group in each M/H Frame including respective amounts of said coded M/H data accompanied by respective sequences of training signal and by a respective sequence of parallelly concatenated convolutionally coded (PCCC'd) Transmission Parameter Channel (TPC) signal and by a respective sequence of parallelly concatenated convolutionally coded (PCCC'd) Fast Information Channel (FIC) signal, the respective said sequence of TPC signal in each said M/H Group containing bits indicative of the TPC protocol -used in the version of the M/H broadcast standard used in transmitting that said sequence of TPC signal, said receiver apparatus comprising:
a PCCC signaling decoder arranged for decoding said sequences of PCCC'd TPC signal to generate respective sequences of decoded TPC signal, said PCCC signaling decoder further arranged for decoding and de-interleaving said PCCC'd and block-interleaved FIC signal to generate successive FIC-Chunks;
a TPC protocol version selector for selecting from each said sequence of decoded TPC signal the bits indicative of the TPC protocol version used in transmitting said M/H Group including that said sequence of TPC signal and the others of said M/H Group included in the same M/H Parade;
a TPC protocol version decoder connected for signaling its determination of when said bits selected by said TPC protocol version selector are of a value outside an acceptable range for continuing decoding operations within said receiver apparatus respective to the coded M/H data in the respective M/H Parade to which the current said sequence of decoded TPC signal pertains; and
a decoding control unit connected for responding to the bits selected by said TPC protocol version selector, said decoding control unit selectively directing cessation of said decoding operations within said receiver apparatus but otherwise interpreting in accordance with the TPC protocol version specified by the bits selected by said TPC protocol version selector from a currently received one of said sequences of TPC signal the commands contained in the other bits of said currently received one of said sequences of TPC signal to control the decoding operations of said receiver apparatus according to said commands as so interpreted, said decoding control unit connected for directing cessation of said decoding operations within said receiver apparatus responsive to said TPC protocol version decoder signaling its determination that said bits selected by said TPC protocol version selector are of a value outside an acceptable range for continuing decoding operations within said receiver apparatus respective to the coded M/H data in the respective M/H Parade to which the current said sequence of decoded TPC signal pertains.

8. Receiver apparatus as set forth in claim 7, further comprising:
an FIC protocol version selector for selecting from each said FIC-Chunk the bits indicative of the FIC protocol version used for its transmission; and
an FIC protocol version decoder connected for signaling its determination of when said bits selected by said FIC protocol version selector are of a value outside an acceptable range for continuing decoding operations within said receiver apparatus, said decoding control unit connected for responding to such determination by said FIC protocol version decoder to direct cessation of said decoding operations within said receiver apparatus.

9. The combination comprising:
receiver apparatus for receiving digital data in 8VSB signal form, at least part of which digital data comprises M/H data coded for transmission in robust form for reception by mobile receivers or other portable receivers, said coded M/H data encapsulated within payload portions of MPEG-2-compliant packets referred to as MHE packets that are Reed-Solomon coded and convolutionally byte interleaved before being ⅔ trellis coded, each M/H Group in each M/H Frame including respective amounts of said coded M/H data accompanied by sequences of training signal and a sequence of coded Transmission Parameter Channel signal and a sequence of coded Fast Information Channel signal, prescribed portions of said coded M/H data being internet protocol (IP) packets the respective headers of which contain version information indicative of the version of M/H broadcast standard used for transmitting those IP packets, said receiver apparatus decoding at least selected ones of said sequences of said coded Transmission Parameter Channel signal to generate corresponding sequences of decoded Transmission Parameter Channel signal, said receiver apparatus decoding at least selected portions of said coded Fast Information Channel signal to generate respective Chunks of decoded Fast Information Channel signal, said receiver apparatus decoding said coded M/H data from selected ones of said M/H Groups in each of a succession of M/H Frames, such decoding of said coded M/H data being done in accordance with instructions contained within said sequences of said decoded Transmission Parameter Channel signal, and such decoding culminating in the reproduction of at least some of said IP packets as reproduced IP packets; and
further receiver apparatus including a micro-processor connected for receiving said reproduced IP packets from the aforesaid receiver apparatus, said micro-processor determining from the respective headers of said reproduced IP packets whether they are one of the types that can be usefully further processed within said micro-processor in accordance with the programming of said micro-processor, said microprocessor continuing to process fully only those of said reproduced IP packets that are one of the types that can be usefully further processed within said micro-processor.
